(19) United States
(12) Patent Application Publication
(10) Pub. No.: US 2026/0186791 A1
(43) Pub. Date: Jul. 2, 2026

(54) PARAMETERIZATION AND CONTROL OF DEVICE PROCESSING MACHINES

(71) Applicant: Assurant, Inc., New York, NY (US)

(72) Inventors: Abdiel Mireles, Nashville, TN (US); Harrison Hanks, La Vergne, TN (US); Derek Lipinski, Murfreesboro, TN (US); Arnav Gaur, Nashville, TN (US); Brandon Johnson, Brentwood, TN (US)

(21) Appl. No.: 19/436,702

(22) Filed: Dec. 30, 2025

Related U.S. Application Data
(60) Provisional application No. 63/740,849, filed on Dec. 31, 2024.
(60) Provisional application No. 63/740,852, filed on Dec. 31, 2024.

(51) Int. Cl. G06F 9/445

(52) U.S. Cl. CPC G06F 9/44505

(57) ABSTRACT

Embodiments of the present disclosure provide methods, apparatuses, and computer program products configured to receive input commands from at least one client terminal and translate the input commands into one or more device processing machine commands. In embodiments of the present disclosure, the device processing machine commands comprise at least one updated dynamic parameter configured to update an existing dynamic parameter of at least one of the plurality of device processing machines. Embodiments of the present disclosure provide methods, apparatuses, and computer program products further configured to transmit one or more commands to the at least one of the plurality of device processing machines to automatically reconfigure a function of the at least one of the plurality of device processing machines.

### CROSS-REFERENCE TO RELATED CASES

This application claims the benefit of U.S. Provisional Patent Application No. 63/740,849, filed Dec. 31, 2024, and U.S. Provisional Patent Application Ser. No. 63/740,852, filed Dec. 31, 2024, both of which are incorporated by reference into this application in their entireties.

### TECHNICAL FIELD

Embodiments of the present disclosure are generally directed to a parameterization and control of device processing machines.

### BACKGROUND

Large processing facilities and groups of processing facilities may include a number of discrete machines for physically handling and performing various operations in association with objects, such as devices. Each machine may require individual programming and updating, and the process must be done manually and at the physical location of the machine. Applicant has discovered various technical problems associated with conventional methods, systems, and tools for controlling such machines and systems. Through applied effort, ingenuity, and innovation, Applicant has solved many of these identified problems by developing the embodiments of the present disclosure, which are described in detail below.

### BRIEF SUMMARY

Embodiments of the present disclosure include a system comprising at least one client terminal configured to receive input commands from a user, a plurality of device processing machines each comprising a controller, and at least one server in electronic communication with the at least one client terminal and the plurality of device processing machines via a network, the at least one server comprising at least one processor and at least one non-transitory computer readable medium comprising computer program instructions. The computer program instructions, when executed by the at least one processor, cause the at least one server to: receive the input commands from the at least one client terminal, translate the input commands into one or more device processing machine instruction sets, the device processing machine instruction sets comprising at least one updated dynamic parameter configured to update an existing dynamic parameter of at least one of the plurality of device processing machines, and transmit one or more instruction sets to the at least one of the plurality of device processing machines to automatically reconfigure a function of the at least one of the plurality of device processing machines.

In at least some embodiments, the system is configured to receive operational data corresponding to the plurality of device processing machines, and determine one or more performance metrics of the plurality of device processing machines based on the operational data.

In at least some embodiments, the system further comprises a translation framework configured to translate user input to a set of parameter update instructions to each of the plurality of device processing machines, wherein the set of parameter update instructions for a corresponding device processing machines configures the corresponding device processing machine to execute a function according to an overall initial goal of the user input.

In at least some embodiments, translating the input commands into one or more device processing machine instruction sets comprises applying the input commands to a generative AI model to create the one or more instruction sets, and wherein the set of parameter update instructions include instructions corresponding to prioritization of processing devices of the generative AI model.

Embodiments of the present disclosure further include an apparatus comprising at least one processor and at least one non-transitory computer readable storage medium comprising computer program instructions that, when executed by the at least one processor, cause the at least one processor to receive an input command for configuring one or more device processing machines, translate the input command into at least one parameter update instruction set corresponding to the one or more device processing machines, and provide the at least one parameter update instruction set to the one or more device processing machines.

In at least some embodiments, the apparatus is further configured to detect a machine malfunction associated with at least one of the one or more device processing machines based at least in part on a set of received operational data, and transmit one or more instruction sets to the at least one of the one or more device processing machines configured to automatically reconfigure a function of the at least one of the one or more device processing machines to compensate for the machine malfunction.

In at least some embodiments, the apparatus is further configured to send one or more repair instruction sets responsive to detecting the machine malfunction.

In at least some embodiments, the one or more device processing machines comprises a visual inspection machine comprising at least one programmable logic controller.

In at least some embodiments, the apparatus is further configured to send a first set of parameter update instructions to a first subset of the one or more device processing machines, and send a second set of parameter update instructions to a second subset of the one or more device processing machines.

In at least some embodiments, the apparatus is further configured to automatically integrate a new machine into a system comprising the one or more device processing machines by transmitting the one or more instruction sets to the new machine, thereby configuring the new machine according to an operating mode of the one or more instruction sets.

In at least some embodiments, the apparatus is further configured to receive one or more signals from the one or more device processing machines indicative of device throughput with respect to the one or more device processing machines, detect a system wide throughput issue based at least in part on the device throughput, and transmit one or more parameter update instruction sets configured to rebalance the flow of devices through the one or more device processing machines to improve the device throughput of the system.

Embodiments of the present disclosure include a system comprising at least one client terminal configured to receive input commands from a user, a plurality of device processing machines each comprising a controller, and at least one server in electronic communication with the at least one client terminal and the plurality of device processing machines via a network, the at least one server comprising at least one processor and at least one non-transitory computer readable medium comprising computer program instructions. The computer program instructions, when executed by the at least one processor, cause the at least one server to: receive the input commands from the at least one client terminal, translate the input commands into one or more device processing machine instruction sets, the device processing machine instruction sets comprising at least one updated dynamic parameter configured to update an existing dynamic parameter of at least one of the plurality of device processing machines, and transmit one or more instruction sets to the at least one of the plurality of device processing machines to automatically reconfigure a function of the at least one of the plurality of device processing machines.

In at least some embodiments, the system is configured to receive operational data corresponding to the plurality of device processing machines, and determine one or more performance metrics of the plurality of device processing machines based on the operational data.

In at least some embodiments, the system further comprises a translation framework configured to translate user input to a set of parameter update instructions to each of the plurality of device processing machines, wherein the set of parameter update instructions for a corresponding device processing machines configures the corresponding device processing machine to execute a function according to an overall initial goal of the user input.

In at least some embodiments, translating the input commands into one or more device processing machine instruction sets comprises applying the input commands to a generative AI model to create the one or more instruction sets, and wherein the set of parameter update instructions include instructions corresponding to prioritization of processing devices of the generative AI model.

Embodiments of the present disclosure further include an apparatus comprising at least one processor and at least one non-transitory computer readable storage medium comprising computer program instructions that, when executed by the at least one processor, cause the at least one processor to receive an input command for configuring one or more device processing machines, translate the input command into at least one parameter update instruction set corresponding to the one or more device processing machines, and provide the at least one parameter update instruction set to the one or more device processing machines.

In at least some embodiments, the apparatus is further configured to detect a machine malfunction associated with at least one of the one or more device processing machines based at least in part on a set of received operational data, and transmit one or more instruction sets to the at least one of the one or more device processing machines configured to automatically reconfigure a function of the at least one of the one or more device processing machines to compensate for the machine malfunction.

In at least some embodiments, the apparatus is further configured to send one or more repair instruction sets responsive to detecting the machine malfunction.

In at least some embodiments, the one or more device processing machines comprises a visual inspection machine comprising at least one programmable logic controller.

In at least some embodiments, the apparatus is further configured to send a first set of parameter update instructions to a first subset of the one or more device processing machines, and send a second set of parameter update instructions to a second subset of the one or more device processing machines.

In at least some embodiments, the apparatus is further configured to automatically integrate a new machine into a system comprising the one or more device processing machines by transmitting the one or more instruction sets to the new machine, thereby configuring the new machine according to an operating mode of the one or more instruction sets.

In at least some embodiments, the apparatus is further configured to receive one or more signals from the one or more device processing machines indicative of device throughput with respect to the one or more device processing machines, detect a system wide throughput issue based at least in part on the device throughput, and transmit one or more parameter update instruction sets configured to rebalance the flow of devices through the one or more device processing machines to improve the device throughput of the system.

Embodiments of the present disclosure include at least one non-transitory computer-readable storage medium having computer program code stored thereon that, in execution with at least one processor, configures the at least one processor to receive an input command for configuring one or more device processing machines, translate the input command into at least one parameter update instruction set corresponding to the one or more device processing machines, and provide a portion of the at least one parameter update instruction set to each of the one or more device processing machines.

Embodiments of the present disclosure include a computer-implemented method comprising receiving, by one or more processors, an input command for configuring one or more device processing machines, translating, by the one or more processors, the input command into at least one parameter update instruction set corresponding to the one or more device processing machines, and providing, by the one or more processors, the at least one parameter update instruction set to the one or more device processing machines.

Embodiments of the present disclosure include a system comprising a device processing machine comprising network communication circuitry and a controller comprising a non-transitory computer readable medium comprising computer program instructions that, when executed by a processor, cause the controller to execute one or more functions of the device processing machine, the computer program instructions defining one or more dynamic parameters comprising an integer and a listener function, the listener function configured to receive and monitor signals received by the network communication circuitry for one or more parameter update instructions, wherein the device processing machine is configured to receive the one or more parameter update instructions and update at least one of the one or more dynamic parameters in response to the one or more parameter instructions to alter at least one function of the device processing machine.

In at least some embodiments, one or more states of the one or more dynamic parameters are configured to place a corresponding function of the device processing machine into a defined operational state.

In at least some embodiments, the defined operational state configures execution of the corresponding function of the device processing machine to provide a corresponding defined throughput condition.

In at least some embodiments, the one or more dynamic parameters correspond to a writable variable configured to trigger a change in the writable variable responsive to a received parameter instruction.

In at least some embodiments, the device processing machine is configured to capture at least one image of a device and generate a grade of the device based on an analysis of the at least one image, and wherein one or more states of the at least one of the one or more dynamic parameters configure the functioning of one or more grading criteria elements of the device processing machine such that a threshold for a specific grade is adjusted according to the one or more states of the dynamic parameter.

In at least some embodiments, the device processing machine is configured to send a device to two or more locations based on an outcome of analysis of the device, and wherein one or more states of the dynamic parameter configure how the device processing machine filters devices to the two or more locations based on the analysis of the device.

In at least some embodiments the one or more states of the dynamic parameter configure operation of one or more routing mechanisms configured to send the device to the two or more locations.

Embodiments of the present disclosure include a computer-implemented method comprising defining one or more dynamic parameters comprising an integer and a listener function of a device processing machine, the listener function configured to receive and monitor signals received by a corresponding network communication circuitry for one or more parameter instructions, receiving the one or more parameter update instructions, and updating at least one of the dynamic parameters in response to the one or more parameter instructions to alter at least one function of the device processing machine.

Embodiments of the present disclosure include at least one non-transitory computer-readable storage medium having computer program code stored thereon that, in execution with at least one processor, configures the at least one processor to define one or more dynamic parameters comprising an integer and a listener function of a device processing machine, the listener function configured to receive and monitor signals received by a corresponding network communication circuitry for one or more parameter update instructions, receive the one or more parameter update instructions, and update at least one of the one or more dynamic parameters in response to the one or more parameter instructions to alter at least one function of the device processing machine.

Various other embodiments are also described in the following detailed description and in the attached claims.

### BRIEF DESCRIPTION OF THE SEVERAL VIEWS OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure. The description of the illustrative embodiments may be read in conjunction with the accompanying figures. It will be appreciated that for simplicity and clarity of illustration, elements illustrated in the figures have not necessarily been drawn to scale. For example, the dimensions of some of the elements are exaggerated relative to other elements.

FIG. 1 is a diagram of a multi-stage automated processing line system that may process devices in accordance with one or more embodiments of the present disclosure.

FIG. 2 is a diagram of an exemplary device parameterization system in accordance with one or more embodiments of the present disclosure.

FIG. 3 illustrates a block diagram of an example apparatus according to one or more described features of one or more embodiments of the disclosure.

FIG. 4 provides an example server system in accordance with some embodiments of the present disclosure.

FIG. 5 provides an example device processing machine in accordance with some embodiments of the present disclosure.

FIG. 6 illustrates a flowchart representing a process 600 for parameterizing and changing an operational state of one or more device processing machines in accordance with one or more embodiments of the present disclosure.

FIG. 7 illustrates a flowchart representing a process 700 as executed by a client terminal, a server system, and a device processing machine in accordance with one or more embodiments of the present disclosure.

FIG. 8 illustrates a flowchart representing a model learning framework.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations. In some embodiments, numerical designations such as “first”, “second”, “third”, etc. may be given to various apparatuses and processes without denoting a relative importance between the respective apparatuses and processes or requiring a specific order or number of apparatuses and processes. For example, embodiments having a “first” device, a “second” device, and a “third” device may have other embodiments in which only the first and third device are used. In each instance, they may equivalently be referred to as one or more of a plurality of devices without numerical designation.

### OVERVIEW

Large processing facilities and groups of processing facilities may include a number of discrete machines for physically handling and performing various operations in association with objects, such as devices. Such facilities and the systems associated therewith may include, but are not limited to, complex systems of physically interoperating machines such as processing lines, packing and shipping warehouses, other industrial and/or commercial manufacturing facilities, reverse logistics facilities, and the like. Moreover, an enterprise may include facilities and other related actors that are outside a single physical location, such as multiple remote processing facilities, service providers, suppliers, vendors, contractors, and the like. Various embodiments of the present disclosure facilitate parameterization and control of these disparate systems and machines.

Computing devices such as mobile devices including smartphones and tablet computers are now ubiquitous amongst the general public, and new makes and models of mobile devices are released frequently. In an example embodiment of the aforementioned processing facilities, managing the reverse-logistics for an enterprise operation dealing with the intake, inspection, refurbishment, and redistribution of mobile devices may be an untenable task requiring substantial amounts of hardware and processing resources and for which every incremental improvement in automation returns significant efficiency and speed improvements for the system. For context, example challenges for enterprises that deal in reverse-logistics (e.g., reverse logistics of devices, such as mobile devices) is grading and parallelly processing devices in accordance with different protocols and control instructions, such as filtering out the mobile devices that do not meet quality control standards, refurbishing devices with dedicated machines, and directing devices along different channels of downstream operation. For example, before instructing a system to refurbish, reformat, recondition, repair, redistribute, and/or otherwise manage a mobile device, the system may include one or more device processing machines configured to determine whether the mobile device has any physical damage or internal electronic damage that preclude the mobile device from being reused and/or redistributed to consumers, and in some instances, allocating one or more particular logistical channels to a device based on its condition. In a high-volume reverse-logistics environment, correctly identifying one or more defects associated with one or more mobile devices (e.g., physical damage on the edge of a respective mobile device, software problems on the device operating system, etc.) is a technically complex and an inefficient process. Moreover, combined with these initial technical challenges, large processing environments must further ensure operability and throughput on many disparate processing machines and collectively coordinate operation of the machines in unison. Furthermore, as will be described herein, current solutions to these problems are inefficient and consume large amounts of technical resources, including by requiring separate reconfiguring of each individual device processing machine when changes to the individual machine operation or system wide operation are needed. For example, many solutions may require individual interaction with (e.g., reprogramming of) any number of machines configured for processing or otherwise analyzing devices to update the operations of said machines.

The aforementioned systems may use one or more control systems, which may control various devices to manipulate, analyze, and perform work on various objects (e.g., mobile devices). Such systems suffer from numerous deficiencies associated with configuring the various devices working on the objects efficiently. Further, systems for device processing leverage device processing machines which often require individual management and configuration, thereby creating labor intensive tasks. Additionally, such device processing machines may be configured with minimal memory, thereby limiting an amount of space available for configuration information. In this regard, Applicant has addressed these and other technical problems by inventing various methods, systems, and apparatuses capable of one or more device parameterization operations, including but not limited to solving each of the foregoing deficiencies, both alone and in various combinations.

Embodiments of the present disclosure provide centralized control of a plurality of device processing machines present with respect to an overall device processing system. The techniques as described herein enable parameterization of the plurality of device processing machines such that said machines may be controlled and configured remotely without requiring individualized adjustments to each machine each time a machine is configured for different operational states or function(s). A device processing machine's code is configured with at least one parameterized variable (in some embodiments, an int and a corresponding listener) which allows the device processing machine to be managed and controlled remotely (e.g., by receiving and executing new code through the parameterized variable(s)) by a server system or a client device, for example. By enabling remote control and management of the device processing machines, techniques as described herein additionally enable automated adjustments to the device processing machines responsive to overall system conditions, such as rerouting processing to accommodate a malfunction or adjusting throughput of various devices responsive to detected market conditions such as a new product release. Further, embodiments of the present disclosure enable a user to provide commands to the device processing machines in natural language, as the system translates natural language commands into corresponding parameter update commands which are comprehensible by the device processing machines. By enabling such natural language commands, for example, the techniques as described herein offer increased usability of such control mechanisms by enabling a user to control the functioning of the device processing machines without requiring knowledge of a language interpretable by the device processing machines. Further yet, machine learning components of the techniques as described herein enable automated generation and implementation of parameterized updates to the device processing machines responsive to detected conditions. As such, the techniques as described herein greatly improve the usability, reliability, and efficiency of device processing systems which utilize these techniques.

### Definitions

“Device processing system” refers to a system comprising hardware, software, or a combination of hardware and software configured to process or otherwise analyze various features of a subject device (such as a mobile device) and/or handle or manipulate a subject device. In some embodiments, the device processing system may include one or more multi-axis robots, one or more imaging devices (e.g., cameras, scanners, or the like), one or more computing devices, one or more conveyors, one or more polishing devices, one or more cleaning devices, one or more other tools, one or more cameras, one or more data stores, and/or computer-coded instructions (e.g., one or more software applications) that are configured for execution via the one or more computing devices and/or stored in one or more data store(s). In one or more embodiments, the various software and/or hardware components of the device processing system may communicate via one or more networks. For example, the one or more multi-axis robots, the one or more computing devices, the one or more conveyors, the one or more other tools, the one or more cameras, and/or the one or more data stores may communicate via one or more networks.

In various contexts, the device processing system may be embodied by an enterprise-scale reverse-logistics system configured to assess, diagnose, recondition, refurbish, reformat, repair, and/or otherwise manage one or more objects of interest such as, for example, one or more mobile devices. In various contexts, the surfaces associated with the plurality of sides of the edge of the object may be composed of various materials including, but not limited to, glass, plastic, rubber, vinyl, composite materials, aluminum, wood, and/or the like. As such, the device processing system may include at least one device processing machine that is configured to analyze a plurality of objects constructed in various materials to determine whether one or more physical defects are present on an edge of a respective object of the plurality of objects, such as via a camera and corresponding processing systems as described herein. In some embodiments, detection of one or more physical defects may be used by the enterprise-scale reverse-logistics system to control the repair (e.g., identification and installation of parts) or disposition (e.g., identifying components for recycling) of the object via one or more downstream handling and repair device processing machines. In one or more contexts, the device processing system may execute an edge-following operation for a particular object in order to determine whether there are one or more physical defects associated with the object.

“Object” or “object of interest” refers to any three-dimensional object that may be analyzed and/or manipulated by one or more device processing machines (e.g., a handling tool of a device processing machines) of a device processing system. In some embodiments, the object may include a plurality of face surfaces (e.g., a front comprising a screen and a back) connected by corresponding edges in a generally rectangular prismatic shape. In various embodiments, an object may be a device, such as a mobile device.

As used herein, the terms “data,” “content,” “digital content,” “digital content object,” “information,” and similar terms may be used interchangeably to refer to data capable of being transmitted, received, created, modified, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like (sometimes referred to herein as a “network”). Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “circuitry” should be understood broadly to include hardware and, in some examples, may be used with or incorporate corresponding software for configuring the hardware. With respect to components of the apparatus, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like.

“Executable code”, “computer-coded instructions”, and the like refer interchangeably to one or more portions of computer program code storable and/or stored in one or a plurality of locations that is executed and/or executable via one or more computing devices embodied in hardware, software, firmware, and/or any combination thereof (e.g., via one or more circuitries). Executable code may define at least one particular operation to be executed by one or more computing devices. In some embodiments, a memory, storage, and/or other computing device includes and/or otherwise is structured to define any amount of executable code (e.g., a portion of executable code associated with a first operation and a portion of executable code associated with a second operation). Alternatively or additionally, in some embodiments, executable code is embodied by separate computing devices (e.g., a first data store embodying first portion of executable code and a second data store embodying a second portion executable code). In some embodiments, executable code requires one or more processing steps (e.g., compilation) prior to being executed by a computing device.

“Data store”, “storage”, “memory”, and the like refer interchangeably to any type of non-transitory computer-readable storage medium. Non-limiting examples of a data store include hardware, software, firmware, and/or a combination thereof capable of storing, recording, updating, retrieving and/or deleting computer-readable data and information, whether embodied locally and/or remotely and whether embodied by a single hardware device and/or a plurality of hardware devices.

“Data attribute” refers to electronically managed data representing a variable, a particular criteria, or a property having a particular value or status. The value may be statically fixed or dynamically assigned. In some embodiments, a data attribute embodies a particular property of a data object.

“Data value” refers to electronically managed data representing a particular value associated with a particular data attribute.

“Data object” refers to an electronically managed data structure representing a collection of one or more data attributes and/or portions of executable code.

The term “computing device” refers to any computer, processor, circuitry, and/or other executor of computer instructions that is embodied in hardware, software, firmware, and/or any combination thereof. A computing device may enable access to a myriad of functionalities associated with one or more mobile device(s), other computing devices, system(s), and/or one or more communications networks. Non-limiting examples of a computing device include a computer, a processor, an application-specific integrated circuit, a field-programmable gate array, a personal computer, a smart phone, a laptop, a fixed terminal, a server, a networking device, and a virtual machine.

The term “mobile device” refers to any portable computing device, such as, but not limited to, a portable digital assistant (PDA), mobile telephone, smartphone, or tablet computer with one or more communications, networking, and/or interfacing capabilities. Non-limiting examples of communications, networking, and/or interfacing capabilities include CDMA, TDMA, 4G, 5G, NFC, Wi-Fi, Bluetooth, as well as hard-wired connection interfaces such as USB, Thunderbolt, and/or ethernet connections.

The term “device processing machine” refers to any machine configured for processing, analyzing, filtering, or otherwise managing a set of subject devices. In at least some embodiments, a device processing machine may be any machine configured as a part of a device processing system, such as are present in a reverse logistics system, for example. In at least some embodiments, a device processing machine may correspond to a programmable logic controller configured to control the operations of one or more machines in a device processing system. In at least some embodiments, a device processing machine may be, but is not limited to, any of a visual inspection machine configured to determine a condition of a device, an intake machine configured to scan and identify a device, an electronic inspection machine configured to verify proper functioning of the device's electronic components, a polishing machine, a cleaning machine, a storage system, a packaging machine, and/or a fulfillment machine.

The term “client terminal” refers to any interface capable of receiving user input and communicating said input to a server system. A client terminal may be configured in connection with a client device located separately from the server system such that any received user input is transmitted to the server system via a network. In other embodiments, a client terminal may be configured in direct connection with the server system, such that the client terminal is an input interface of the server system that a user may access. A client terminal may be configured as an interface provided to a user device via which the user may communicate with the server system.

The term “input command” refers to any command or instruction provided by a user (e.g., via a client terminal). In some embodiments, an input command may be provided in plain language and ultimately translated into operations understandable by one or more device processing machines. An input command may be provided already in a format usable by the device processing machines such that no further translation is required. In general, an input command may be any instruction or command intended to instruct the operation of a machine configured for device processing.

The term “device processing machine instruction set” or “machine instruction set” refers to any one or more commands or instructions in a language understandable/processable by a device processing machine thereby instructing operation of one or more components of the device processing machine (e.g., when processed and executed by a controller of the device processing machine). A device processing machine instructions set may comprise a plurality of commands or instructions directed to multiple device processing machines to execute a series of distinct functions of the respective device processing machines. A device processing machine instruction set may be transmitted to a networked group of device processing machines with individualized trigger codes for one or more of a plurality of machines, such that each of the plurality of device processing machines may have access to the full machine instruction set while only executing the portion of the machine instruction set directed to the respective device processing machine. In at least some embodiments, a device processing machine instruction set includes an instruction to update a variable (e.g., a dynamic parameter) of the device processing machine to configure the device processing machine into a corresponding mode of operation.

The term “dynamic parameter” refers to a parameter or variable configured to be remotely modified to facilitate remote reconfiguration of a device processing machine. The new dynamic parameter may include an int (e.g., “integer”) and a corresponding listener, such that the variable may be remotely updated or changed. A dynamic parameter may be a variable implemented in a device processing machine's code (e.g., code stored in a non-transitory storage medium and executable by a controller of the device processing machine) and updatable via one or more authorized communication channels to the device processing machine. The listener (or event listener) may be a function configured to wait for an event and subsequently respond to said event according to a scripted response. As used herein, the listener is configured to detect a parameter update function as provided by a transmission to a corresponding device processing machine and respond by rewriting the dynamic parameter according to the received parameter update function. Generally, the dynamic parameters may be a new type of variable that may be configured to control the routing of devices through one or more device processing machines of a device processing system via customization of the variable (e.g., by modifying the underlying integer to make the controller writeable remotely).

The term “operational data” refers to data associated with the operation and/or performance of a device processing machine. The operational data may reflect, for example, a number of devices processed during a specified period of time by one or more device processing machines. The operational data may include subsets corresponding to various models, makes, colors, conditions, ages, and any other number of features. The operational data may reflect performance metrics of the corresponding device processing machine(s), such as a pace at which devices have been processed by the device processing machine(s), and may be used to determine whether a device processing machine is functioning properly, for example. The operational data may additionally or alternatively include status data associated with the device processing machine, such as an activity flag indicating whether the device is “online” or “offline”, an error report, or the like.

The term “operational state” (or, at times, “mode”) refers to a set operations and/or operational parameters governing the functioning of a device processing machine. In at least some embodiments, an operational state includes an operation, or a series of operations intended to configure a device processing machine to process devices according to a set of indicated features. For example, an operational state may indicate a set of operations configuring the device processing machine for filtering out a set of devices of a first make. In at least some embodiments, the

### Example Systems and Apparatuses of the Disclosure

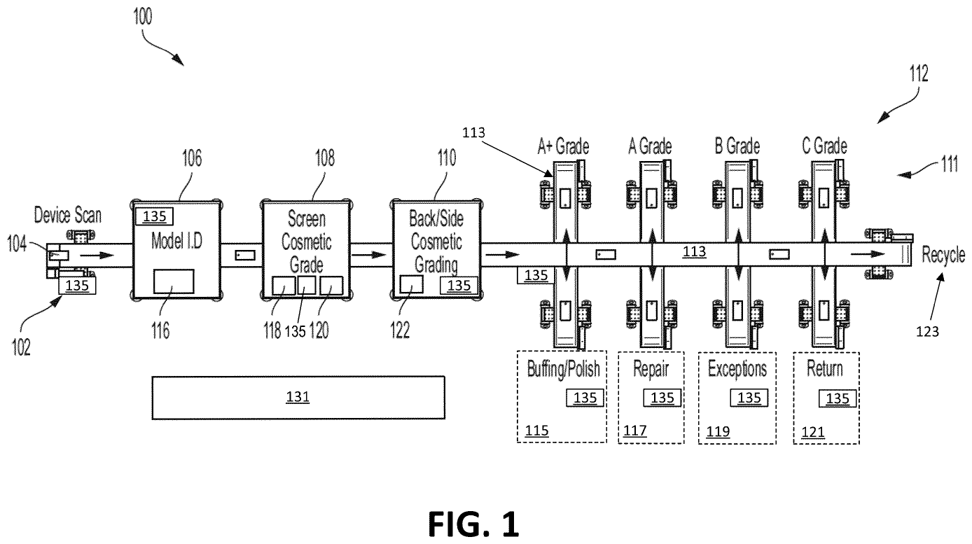

As seen in FIG. 1, in some embodiments, systems and methods disclosed herein may include a multi-stage automated processing line system 100 that may sort and grade and otherwise process devices. FIG. 1 depicts an example processing line system 100 having one, non-limiting example configuration of device processing machines. Embodiments of the present disclosure apply to any number or configuration of device processing machines, such that various machines in the embodiment of FIG. 1 may be duplicated, removed, replaced, or moved and various machines performing any function relevant to object processing may be added to the embodiment of FIG. 1.

As also seen in FIG. 1, in some embodiments, the multi-stage automated processing line system 100 may include multiple processing line stations, systems, and/or devices for executing one or more tasks to process the devices. Many configurations of processing line are possible, and FIG. 1 illustrates one non-limiting example. In some embodiments, the multi-stage automated processing line may comprise a plurality of device processing machines arranged sequentially and/or parallelly in a processing flow. Each device processing machine may be configured to perform one or more functions of the overall processing flow. As described herein, the device processing machines may be defined as part of discrete “stations” for performing various functions associated with the analysis, handling, modification, disposition, and/or other functions associated with a device. In some embodiments, multiple device processing machines (e.g., with separate controllers) may be associated with a single station and/or multiple stations'functionalities may be performed by a single device processing machine.

For example, in some embodiments, a first station 102 of the multiple processing line stations may include an imaging device or other reader configured to scan a bar code, a QR code, or the like associated with one of the devices 104. For example, the first station 102 may, prior to unpackaging, scan a code on the exterior of a box in which the device was shipped or, following unpackaging, scan a code on the exterior of the device itself. A second station 106 of the multiple processing line stations may include an imaging device or physical electronic connection (e.g., USB connector), which may capture and analyze an image of the devices 104 or otherwise identify a model ID of each of the devices 104 (e.g., for corroboration with the scanned bar code and/or additional metadata gathering). In the depicted embodiment, a third station 108 of the multiple processing line stations many be configured to capture an image of at least a front (e.g., screen) side of the device to grade the front, a screen, and/or a camera of each of the devices 104. An example of a device processing machine configured to grade the device is shown in U.S. Pat. No. 11,580,627, which is incorporated by reference herein in its entirety.

In the depicted embodiment, a fourth station 110 of the multiple processing line stations may grade a back and/or sides of each of the devices 104. In some embodiments, the back and/or sides may be graded by the same station as the front (e.g., via multiple cameras pointed at multiple locations and/or via a robot arm or other handling equipment configured to manipulate the device into different orientations). In any of the foregoing stations, one or more robotic arms may be used with end effectors (e.g., suction devices) to manipulate the objects. The device processing system may further include a sorting station 111 of the multiple processing line stations configured to distribute each of the electronic devices 104 to one of a plurality of output stations 112 based on assessments in or from some or all of the initial multiple processing line stations. The downstream stations may include, but are not limited to, a buffing and polishing station 115 configured to prepare top graded devices for distribution, a repair station 117 configured to repair any detected malfunctions or flaws in a device, an exceptions station 119 configured to process lower grade devices, and a return station 121 configured to return certain devices (e.g., returned to the user and/or another machine for further analysis) for yet lower grade devices. In some embodiments, a final, recycle station 123 may dispose of devices that are not otherwise useful based on the initial analysis. As illustrated in the depicted embodiment, some stations may be defined with parallel processing paths for simultaneous processing of devices in multiple machines (e.g., the vertically oriented conveyors 113 in the depicted embodiment adjacent the buffing/polishing 115, repair 117, exceptions 119, and return 121 stations). Various embodiments may include parallel processing for any of the depicted stations and may be configured for throughput and/or reliability.

Various systems and methods for moving the devices through the multi-stage automated processing line system 100 are contemplated. For example, in some embodiments, conveyor belts as known in the art may move the devices through the multi-stage automated processing line system 100, and in some embodiments, a movable tote may move the devices through the multi-stage automated processing line system 100. For example, one or more conveyors 113, carts, robots, bins, or other conveyance devices may be configured to transmit the devices between stations. In some further embodiments, the conveyance device(s) may permit one or more devices to bypass one or more stations. Each conveyance device and each station may be considered a device processing machine itself or may be part of another device processing machine.

In the depicted embodiment, a server system 131 is configured to communicate with controllers 135 associated with the device processing machines of each station 102, 106, 108, 110, 111, 112, 113, 115, 117, 119, 121, 123. Various functions described herein may be performed locally within the controller 135 of each device processing machine or may, in whole or in part, be performed at an external device, such as the server system 131 or an intermediate computing device in communication with the system. In each embodiment, the controller of the device processing machines may be parameterized and controlled (e.g., configured into one or more operational states) to accomplish one or more functions assigned to it in accordance with the various embodiments of the present disclosure.

As described above, the first station 102, if incorporated into the device processing system, may scan the bar code or another electronic identifier associated with each of the devices 104 or a package associated therewith, for example, with a scanning device such as a camera, other code reader, or other image capture device. When the bar code or the other electronic identifier is scanned, server system 131 and/or the controller 135 of the first station 102 may identify and load preliminary information associated with each of the devices 104 from the bar code or the other electronic identifier (e.g., to load predetermined dimensions, attributes, and other features to configure the downstream workflows and track the device through the processing system). In some embodiments, the preliminary information associated with each of the devices 104 may include a manufacturer and model of each of the devices 104 and/or other types of information as would be known or desired by one of ordinary skill in the art. Furthermore, in some embodiments, others of the multiple processing line stations may subsequently add to and/or augment the preliminary information associated with each of the devices 104, while maintaining an ongoing log of the current location and future disposition of the device. For example, in some embodiments, responsive to the first station 102 scanning the bar code or the other electronic identifier, the server system 131 and/or the controller 135 of the first station 102 may generate a database entry in a database that initially contains the preliminary information associated with each of the devices 104, that is, the preliminary information identified from the bar code or the other electronic identifier, and the others of the multiple processing line stations may save additional information associated with each of the devices 104 into the database entry (e.g., grades, anomalies such as electronic or cosmetic defects, underperformance, faults, error codes, and the like).

As described above, the second station 106 may identify the model ID of each of the devices 104. For example, in some embodiments, the server system 131 and/or the controller 135 of the second station 106 may use the preliminary information associated with each of the devices 104 to identify the manufacturer and/or the model of each of the devices 104 and, responsive thereto, identify a set of possible options for the model ID of each of the devices 104. For example, an imaging device may capture an image of a serial number, IMEI, or the like on an exterior of the device (e.g., on a back surface or from the screen of the device) to identify the model and/or other metadata associated with the device. The device processing system may then corroborate the scanned information from the first station 102 with the model ID determined at the second station 106.

Various embodiments for identifying the manufacturer, the model, and/or the other metadata associated with the devices 104 are contemplated and various embodiments of pre-existing and captured data about each device 104 may be stored in the various data stores. For example, in some embodiments, the first station 102 or the second station 106 may include an imaging device 116 that may capture a first image of each of the devices 104, and the server system 131 and/or the controller 135 of the first station 102 or second station 106 can process the first image of each of the devices 104 to identify the manufacturer, the model, and/or the other metadata associated with the devices 104. In some embodiments, the server system 131 and/or the controllers 135 of one or more stations can compare the first image of each of the devices 104 to a first series of pre-stored reference images for which the manufacturer, the model, and/or the other metadata (e.g., model I.D., serial number, IMEI, color, size, screen type, etc.) is known, may identify one of the first series of pre-stored reference images that best matches the first image of each of the devices 104, and may assign to the devices 104 the manufacturer, the model, and/or the other metadata associated with the first series of pre-stored reference images that best matches the first image of each of the devices 104.

Additionally or alternatively, in some embodiments, the server system 131 and/or the controller 135 of one or more stations may parse the first image of each of the devices 104 to identify visual identifying details of each of the devices 104, such as a size of each of the devices 104, a location of the screen of each of the devices 104, and locations and sizes of other elements of each of the devices 104, such as cameras and buttons. Then, the server system 131 and/or the controller 135 can compare the visual identifying details to identifying information of known electronic devices to identify the manufacturer, the model, and/or the other metadata of the devices 104.

Additionally or alternatively, in some embodiments, the server system 131 and/or the controller 135 can execute a device recognition artificial intelligence (“AI”) program or algorithm to identify the manufacturer, the model, and/or the other metadata of each of the devices 104. For example, in a training mode, the device recognition AI program or algorithm may be trained to identify the devices, for example, by feeding the device recognition AI program or algorithm with captured images, sensor scan data, and/or the identifying information of the known devices and, responsive thereto, provide positive and negative feedback for device identifications made by the device recognition AI program or algorithm. Based on the positive and negative feedback, the device recognition AI program or algorithm may develop rules and heuristics that may be used to identify the manufacturer, the model, and/or the model ID of one of the devices 104 when operating outside of a training mode.

As described above, the third station 108 may grade the screen and/or the camera of each of the devices 104, for example, by analyzing the respective surface(s) for defects, including cosmetic defects such as scratches or blemishes and/or by determining whether or to what degree the screen and/or a lens of the camera of each of the devices 104 is damaged, such as detecting cracks, water damage, damaged or inactive pixels, or other damage. In some embodiments, the server system 131 and/or the controller 135 of the third station 108 may use the preliminary information associated with each of the devices 104 and the manufacturer, the model, and/or the other metadata of the devices 104 to grade the screen and/or the camera of each of the devices 104. For example, in some embodiments, the server system 131 and/or the controller 135 can use the manufacturer, the model, and/or the other metadata of the devices 104 to transmit instructions for the third station 108 or positioning elements therein to position lighting elements 118 and an imaging device 120 associated with the third station 108 and adjust parameters of the lighting elements 118 and the imaging device 120 (e.g., physical positioning of the components and/or various attributes such as brightness, exposure, framerate, etc.) so that any cracks in the screen and/or the lens of the camera of each of the devices 104 may be identified without powering on each of the devices 104 and so that an area of each of the devices 104 that the imaging device 120 captures is limited to only that area needed to identify such cracks.

In the depicted embodiment, third station (e.g., screen cosmetic grade station) 108 may include one or more lighting elements 118 and one or more imaging devices 120 (e.g., cameras). Various embodiments of the lighting elements 118 are contemplated. For example, in some embodiments, the lighting elements 118 may include ultraviolet light emitting elements. Additionally or alternatively, in some embodiments, the lighting elements 118 may include non-ultraviolet lighting elements that may be used independently or in connection with the ultraviolet light emitting elements. Additionally or alternatively, in some embodiments, the lighting elements 118 may include multiple, for example, three, separate light elements with variable intensities that may be adjusted by the server system 131 (e.g., by instructing the controller) and/or the controller 135 based on the manufacturer, the model, and/or the other metadata of the devices 104. For example, a first of the lighting elements 118 may include a large planar lighting element positioned at an angle with respect to a section of the conveyor belt or the movable tote within the third station 108 and closest to a first end at which each of the devices 104 enters the third station 108. Then, a second of the lighting elements 118 may be positioned below the conveyor belt or the movable tote, include a width greater than the conveyor belt or the movable tote, and be used to illuminate each of the devices 104 from below, and in these embodiments, the conveyor belt or the movable tote may be at least partially transparent. Finally, a third of the lighting elements 118 may be vertically closer to the conveyor belt or the movable tote than the first of the lighting elements 118 at an opposite end of the third station 108 from the first of the lighting elements 118.

In some embodiments, different configurations and numbers of the lighting elements 118 may be employed in the third station 108. For example, in some embodiments, a physical configuration, optical characteristics, and timing characteristics of the lighting elements 118 may be altered and optimized for use in connection with different screen types of the devices, such as LED-type screens, to facilitate optimized accuracy, for example, greater than 98% accuracy, when grading the screen of each of the devices 104. In particular, the server system 131 and/or the controller 135 may account for changes to and optimizations of polarization patterns, refraction anomalies, exposure rates, and speeds of the lighting elements 118 to facilitate increased production rates when identifying the cracks in the LED-type screens versus LCD-type screens.

Various embodiments for grading the screen and/or the camera of each of the devices 104 are contemplated. For example, in some embodiments, the imaging device 120 may capture a second image of each of the devices 104 while the lighting elements 118 are illuminating each of the devices 104, and the server system 131 and/or the controller 135 can process the second image of each of the devices 104 to identify the cracks in the screen or the lens of the camera of each of the devices 104. In some embodiments, the server system 131 and/or the controller 135 can compare the second image of each of the devices 104 to a second series of pre-stored reference images for which the manufacturer, the model, and/or the other metadata matches the manufacturer, the model, and/or the other metadata of the devices 104, and in these embodiments, each of the second series of pre-stored reference images may include a cracked screen, a cracked camera lens, an uncracked screen, an uncracked camera lens, and combinations thereof. Based on such a comparison, the server system 131 and/or the controller 135 can identify one of the second series of pre-stored references images that best matches the second image of each of the devices 104 and grade the screen and/or the camera of each of the devices 104 based on how closely the second image of each of the devices 104 matches different ones of the second series pre-stored references images.

Additionally or alternatively, in some embodiments, the server system 131 and/or the controller 135 can parse the second image of each of the devices 104 to identify visual characteristics consistent with the screen and/or the lens of the camera of each of the devices 104 being cracked. Then, the server system 131 and/or the controller 135 can compare the visual characteristics to stored information indicative of screens and/or lens of cameras being cracked to identify whether or to what degree the screen and/or the lens of the camera of each of the devices 104 is cracked and, based thereon, grade the screen and/or the camera of each of the devices 104.

Additionally or alternatively, in some embodiments, the server system 131 and/or the controller 135 can execute a screen grading AI program or algorithm to grade the screen and/or the camera of each of the devices 104. For example, in the training mode, the screen grading AI program or algorithm may be trained to identify the cracks in and corresponding grades of the devices, for example, by feeding the screen grading AI program or algorithm with the captured images, the sensor scan data, and/or the identifying information of the known electronic devices with varying grades and different combinations and degrees of the screens and/or the lenses of the cameras being cracked and, responsive thereto, provide the positive and negative feedback for screen and camera grades assigned by the screen grading AI program or algorithm. Based on the positive and negative feedback, the screen grading AI program or algorithm may develop rules and heuristics that may be used to grade the screen and/or the camera of each of the devices 104 when operating outside of the training mode.

Additionally or alternatively, the third station 108 may grade the screen and/or the camera of each of the devices 104 based on an amount of cosmetic wear identified on a front face of each of the devices 104 that is distinct from or short of full ones of the cracks in the screen and/or the lens of the camera of each of the devices 104. Any or all of the aforementioned analyses and data points may be used to determine a grade and ultimately a downstream disposition of each device 104.

As described above, the fourth station 110 may be configured to grade the back and/or the sides of each of the devices 104. As discussed herein, in some embodiments, the front, rear, and/or sides of the device may be visually inspected and graded by the same device processing machine. In some embodiments, the devices 104 may be rotated (e.g., via robot arm) so that, when the back is facing in one direction, such as downwards, while each of the devices 104 is in the first station 102, the second station 106, and/or the third station 104, the back is rotated to face in a second direction, such as upwards, that is opposite the first direction while each of the devices 104 is in the fourth station 110. As such, in some embodiments, the server system 131 and/or the controller 135 in communication with the fourth station 110 may use the preliminary information associated with each of the devices 104 and the manufacturer, the model, and/or the other metadata of the devices 104 to grade the back and/or the sides of each device 104. For example, in some embodiments, the server system 131 and/or the controller 135 can use the manufacturer, the model, and/or the other metadata of the devices 104 to transmit instructions to the fourth station 110 or the positioning elements therein to position an imaging device 122 associated with the fourth station 110 so that the area of each of the devices 104 that the imaging device 122 captures is limited to only that area needed for such grading.

Various embodiments for grading the back and/or the sides of each of the devices 104 are contemplated. For example, in some embodiments, the imaging device 122 may capture one or more images of the back and/or one or more sides of each of the devices 104, and the server system 131 and/or the controller 135 can process the image(s) of each one of the devices 104 in substantially the same manner as the various embodiments of the front analysis process described above. For embodiments in which multiple sides/edges are analyzed for grading, a cumulative grade may be generated for each device 104. Example systems, machines, and processes for inspecting and/or grading one or more devices are described in U.S. Pat. No. 11,580,627 entitled “Systems and Methods for Automatically Grading Pre-Owned Electronic Devices” and filed Jan. 5, 2021; U.S. application Ser. No. 18/794,667 entitled “METHODS, SYSTEMS, APPARATUSES, AND COMPUTER PROGRAM PRODUCTS FOR FOLLOWING AN EDGE OF AN OBJECT” and filed Aug. 5, 2024; U.S. Pat. No. 10,332,249 entitled “Screen Damage Detection for Devices” and filed Mar. 7, 2017, each of which is respectively incorporated by reference herein in its entirety.

In some embodiments, any images captured by the multi-stage automated processing line system 100 may be stored for future use. For example, in some embodiments, the server system 131 and/or the controller 135 can save the first image of each of the devices 104 captured in the first station 102 or the second station 104, the second image of each of the devices 104 captured in the third station 108, and/or the third image of each of the devices 104 captured in the fourth station 110 into the database entry generated by the first station 102.

The example stations depicted in FIG. 1 are merely examples of one possible configuration of the system, and other stations may be used instead of or in addition to one or more of the depicted stations. By way of non-limiting example, one or more cleaning machines, such as the cleaning fixture described in U.S. application Ser. No. 18/397,349 entitled “SYSTEMS, APPARATUSES, AND METHODS UTILIZING A CLEANING FIXTURE” and filed Dec. 27, 2023, and in the system described in U.S. Provisional Application No. 63/615,618 entitled “CLEANING SYSTEM FOR CLEANING AN ELECTRONIC DEVICE and filed Dec. 28, 2023, each of which is respectively incorporated by reference herein in its entirety.

As described above, the sorting station 111 may distribute each of the devices 104 to each of the plurality of output stations 112 (e.g., stations 115, 117, 119, 121) based on the assessments in or from the analysis stations (e.g., the first station 102, the second station 106, the third station 108, and/or the fourth station 110), and each station may define a device processing machine for performing the functions of the respective stations. For example, the plurality of output stations 112 may include (1) a first output station 115 for the devices in need of polishing or buffering, (2) a second output station 117 for the devices in need of repair, (3) a third output station 119 for the devices with specific exceptions, (4) a fourth output station 121 for the devices that need to be returned, (5) a fifth output station 123 for the devices that need to be recycled, and/or (6) other output stations for the devices that have been assigned an overall A+, A, B, or C grade. In some embodiments, one or more of the output stations may direct one or more of the devices back to the initial grading stations 108, 110 for regrading (e.g., after buffing/polish, after repair, after detecting an exception, or after determining that a device needs to be returned but before returning the device).

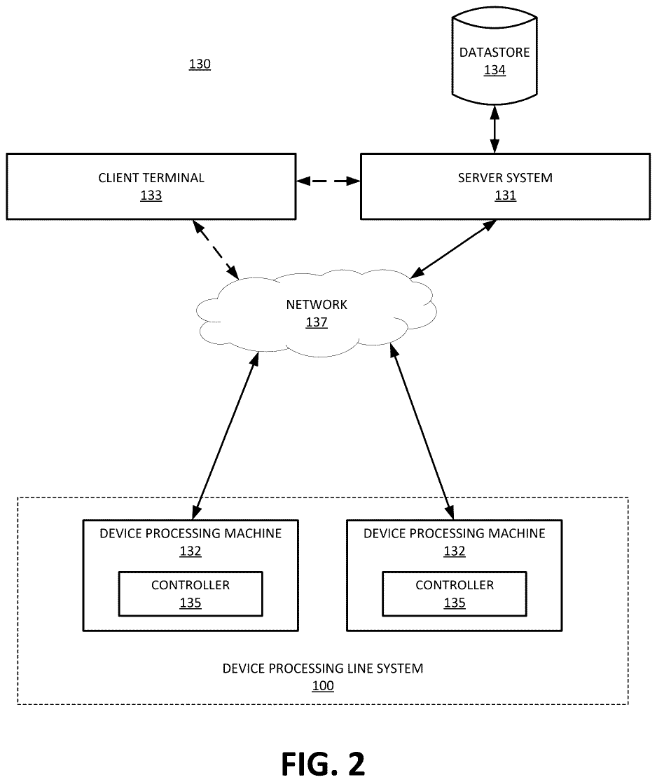

The server system 131 and/or the controllers 135 as shown may be the same server system and controller described with respect to FIG. 2 for controlling operations of the multi-stage automated processing line system 100. In some embodiments, the system may include intermediate control circuitry as an intermediary controller for a single facility or portion thereof that is networked between the server system 131 and the individual controllers 135 of the device processing machines 132. In such embodiments, the intermediate control circuitry may perform a portion of the functions of the controllers 135 and/or server system 131 to facilitate interaction and interoperation between the server system and the individual controllers. In some such embodiments, the intermediate control circuitry may be parameterized and controlled in substantially the same manner as the controllers described herein.

For example, in some embodiments, one or more portions of the functions performed in association with the first station 102, the second station 106, the third station 108, the fourth station 110, the sorting station 111, and/or various sub-components thereof may be controlled by a single central controller or multiple controllers. In various embodiments described herein, each device processing machine 132, shown in FIG. 2, includes an onboard controller 135 (e.g., a programmable logic controller, “PLC”) that controls the functions of the various components at a device level with or without additional layers of more centralized control. For example, each of the first station 102, the second station 106, the third station 108, the fourth station 110, the sorting station 111, and the various sub-components thereof may include a controller 135 comprising a respective transceiver device, a respective memory device, one or more respective processors, and respective executable control software, which may be in communication with respective external control circuitry, for example, the server system 131 and/or the controller(s) 135. In some embodiments, the respective executable control software of each of the first station 102, the second station 106, the third station 108, the fourth station 110, the sorting station 111, and the various sub-components thereof may be stored on a respective transitory or non-transitory computer readable medium, including, but not limited to local computer memory, RAM, optical storage media, magnetic storage media, flash memory, and the like, and some or all of the respective controllers 135, including the respective programmable processors, and the respective executable control software of each of the first station 102, the second station 106, the third station 108, the fourth station 110, the sorting station 111, and the various sub-components thereof may execute and control at least some of the methods described herein.

In some embodiments, the first station 102, the second station 106, the third station 108, the fourth station 110, the sorting station 111, and various sub-components thereof are directed by a server system, such as server system 131, which may transmit instructions directly or indirectly to the individual controllers 135 of the device processing machines which may configure the device processing machines into one or more operational states as described herein (e.g., via modification of the dynamic parameters respectively stored for each controller 135).

In at least some embodiments, the processing line system 100 may additionally include an electronic inspection machine configured for testing the electronic components of a device. For example, an electronic inspection machine may be configured to connect to the device via its data access port and run one or more diagnostic functions to verify proper functioning of the electronic components of the device. In at least some embodiments, the electronic inspection machine may be configured to test the life of the device's battery. In at least some embodiments, the electronic inspection machine may be configured to verify proper functioning of a device's operating system. One example of an electronic inspection machine is detailed in U.S. Provisional Application No. 63/615,548 entitled “ROBOT ENABLED MOBILE DEVICE MANIPULATION SYSTEM, METHOD, AND APPARATUS” and filed Dec. 28, 2023, which application is incorporated by reference herein in its entirety.

In at least some embodiments, the processing line system 100 may additionally include one or more packaging/fulfillment machines. For example, one or more packaging/fulfillment machines may be disposed downstream of one or more of the respective buffing/polishing station 115, repair station 117, exceptions station 119, return station 121, and/or recycling station 123 illustrated in FIG. 1. A packaging machine may be configured to, responsive to determining that a device is in adequate condition for distribution, administer an appropriate package for the device and facilitate packaging the device and directing the package to a shipping or other transport station. In at least some embodiments, the packing machine is configured to determine an appropriate package based on the model of the device. A packaging machine may further be configured to safely store the device, using, for example, one or more robotic mechanisms for placing the packaged device in a storage location such as a bin or a shelf (e.g., prior to shipping).

FIG. 2 is a diagram of an exemplary device parameterization system 130 configured for processing devices (e.g., mobile devices) in accordance with one or more embodiments of the present disclosure. The exemplary device parameterization system 130 includes a server system 131, one or more device processing machines 132 (e.g., two in the depicted embodiment but any number of machines may be used, including the various numbers illustrated and described with respect to FIG. 1), and a client terminal 133. The components of device parameterization system 130 may be configured to parameterize one or more machines (such as device processing machine(s) 132) to enable individualized control of each of the one or more machines to reflect different performance based on issued parameters. In various embodiments, device parameterization system 130 is configured to process one or more objects, such as mobile devices, according to one or more features of said one or more objects and one or more statuses of each of the one or more features indicating a desired state/condition/other data value corresponding to the one or more parameters. For example, the components of device parameterization system 130 may be configured to sort, filter, or otherwise process the one or more objects according to features including, but not limited to, make, size, condition, color, model, and the like. The device parameterization system 130 may reconfigure any one or more of the device processing machines 132 to carry out or adjust any of the foregoing process or execute any other code within the controller of the respective devices using the embodiments described herein.

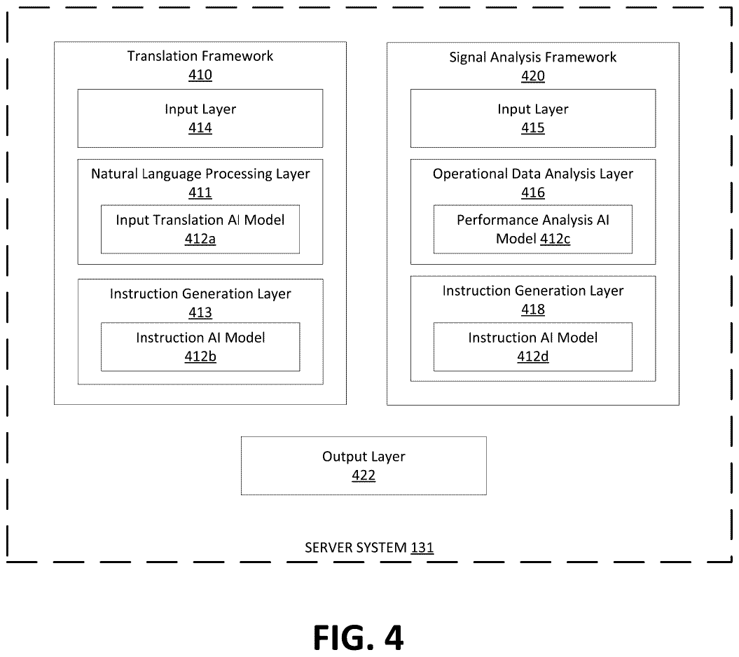

In various embodiments, the server system 131 is configured for global control of a plurality of at least one set of local machines, such as the device processing machine(s) 132, located in at least one facility. The server system 131 may be configured to provide parameterization updates to the device processing machine(s) 132, such that each device processing machine 132 may be configured separately to execute one or more updated functions. In various embodiments, the server system 131 is configured to translate centralized or global inputs regarding system functions into sets or one or more machine level and machine interpretable instructions. For example, the server system 131 may be configured to receive one or more user instructions instructing the device parameterization system 130 to filter out and discard objects which are below a certain condition, for example. In fulfillment of this global instruction, as an example, the server system 131 may reconfigure the conveyor 113 to direct all B and C grade devices directly to the recycling station 123 instead of proceeding to the exceptions 119 or return 121 station. An example server system 131 is described in greater detail with respect to FIG. 4.

In at least some embodiments, such as those wherein there exist a plurality of device processing machines 132, the server system 131 may be configured to provide different instructions to each device processing machine 132. For example, responsive to an instruction that, for example, indicates a desired distribution of devices being processed, the server system 131 may send differing instructions to each of the device processing machines 132. Consider an embodiment where the server system 131 receives instructions to configure the device processing machines 132 to focus on processing devices of a first make, for example. In such an embodiment, the server system 131 may issue instructions to a majority (80%, for example) of the device processing machines to filter out devices of any make other than the first make. The server system 132 may issue instructions to the remaining device processing machines to continue processing all devices, such that the first make is prioritized in aggregate, but some devices of other makes are still processed. In another example, the server system 131 may receive a user command to prioritize a particular model of device (e.g., “Model A”). In response, the server system 131 may transmit computer-readable instructions to cause the model I.D. station 106 to flag Model A devices, and the server system 131 may separately cause the grading stations 108, 110 to only grade Model A devices and direct non-Model A devices to a holding area. Alternatively, in response to the same command as the preceding example, the server system 131 may transmit computer-readable instructions to cause the model I.D. station 106 to flag Model A devices, and the server system 131 may separately cause the buffing/polishing system 115 and packaging/fulfillment system to only ship Grade A+Model A devices, while directing other devices to a storage area or a lower throughput parallel line. An example buffing/polishing system is described in U.S. application Ser. No. 18/315,036 entitled “Methods, Systems, And Apparatuses For User Device Repair And Conditioning” and filed May 10, 2023, which application is incorporated by reference herein in its entirety.

In various embodiments, the device processing machine(s) 132 may each comprise a controller 135 (e.g., a PLC), which is a computer configured to control industrial processes and machines. In various embodiments, the device processing machine(s) 132, via the controllers 135, are each configured to monitor inputs from one or more sensors and subsequently issue instruction sets to control outputs that run machines. In various embodiments, the controllers 135 device processing machine(s) 132 are programmed with logic functions that dictate how the device processing machine(s) 132 respond to a certain input, and may therefore be used to automate specific processes, machines, or even entire production lines. In various embodiments, each controller 135 may be positioned in or within close proximity to the various components of the respective device processing machine 132 and may be configured to monitor various inputs at the device processing machine 132 and generate rapid (e.g., real time) responses to those inputs consistent with its programming.

While traditional PLCs require downloading hard-coded instructions via a dedicated programming device (e.g., a laptop) physically interfaced with each PLC, the server system 131 of the present disclosure may configure or reconfigure each of the controllers 135 of the respective device processing machine(s) 132 centrally using a new variable type (e.g., a dynamic parameter) comprising an int and a listener. During operation, the listener may listen (e.g., via the network) for a trigger code sequence and upon detection of the trigger code sequence may modify the int with the newly instructed configuration. The remaining functions of the controller 132 may then call and edit the int, thereby automatically updating each functionality of the device based on the centrally transmitted dynamic parameter. The new dynamic parameter may be added to an existing controller 135 via the aforementioned dedicated programming device to enable or retrofit a controller for centralized control. In at least some embodiments, each device processing machine 132 is configured to transmit status updates to the server system 131. For example, the status updates may comprise a current parameter state and/or one or more operational metrics or other operational data corresponding to a current operating condition of the corresponding device processing machine 132. The device processing machines 132 may send status updates continuously, periodically, or in response to one or more triggers (e.g., a fault). The device processing machine(s) 132 (e.g., via the corresponding controller(s) 135) may be configured to receive updates from the server system 131. For example, the device processing machine(s) 132 and/or the corresponding controller(s) 135 may be configured to process instructions received in a standard control syntax to determine one or more necessary parameterization updates with respect to the device processing machine(s) 132. Parameterizing the device processing machines may refer to reconfiguring the controllers of the device processing machines to accept the standard control syntax. For example, the device processing machines may be configured to initiate an FTTP over WebSockets connection (or a similar tunnel) to the server system 131. The parameterized controller may then, by way of nonlimiting example, use parameterized variables associated with the NKTT library made by BNR or a similar library to authenticate the sender from the tunnel connection (e.g., via the authentication processes described herein) and accept the NKTT inputs. The device processing machine 132 may be configured to listen to signals on a network for one or more triggers identifying an instruction as directed to the particular machine (e.g., via one or more wired or wireless protocols and associated packets of data).

As depicted, each device processing machine 132 includes a controller 135. Controller 135 may be configured to receive one or more instructions corresponding to the functioning of the corresponding device processing machine 132. In various embodiments, controller 135 is configured to process the received instructions to determine one or more updates to the device processing machine parameters corresponding to the received instructions. For example, controller 135 may be configured to update a device variable configured to control the manner in which the device processing machine 132 will filter or otherwise process devices. In various embodiments, controller 135 pushes an update to the variables of the device processing machine 132 by modifying a memory section of the data storage of the controller, such that the updated variable(s) configure the device processing machine 132 to process devices according to the received instructions, rather than a previous configuration. In various embodiments, the server system is configured to receive instructions from client terminal 133, translate said instructions into a formats and specific instructions processable/usable by the respective device processing machine(s) 132, and subsequently transmit the translated instructions to the device processing machine(s) 132.

In various embodiments, the client terminal 133 may be a client computing system configured with an interface or mechanism via which a user may provide instructions to the server system 131 and/or the device processing machine 132. In the depicted embodiment, the client terminal 133 is configured to provide instructions to the server system 131, which may be translated and relayed to the device processing machine(s) 132. In various additional embodiments (not depicted), the device processing machine(s) 132 may be configured to receive instructions directly from the client terminal 133, such as in embodiments where the client terminal 133 corresponds to an authorized device. In such embodiments, the controller 135 of the device processing machine 132 and/or the client terminal 135 is configured with translation capabilities such that the controller 135 may interpret the received instructions.

In various embodiments, a network 137 is integrated with the device parameterization system 130 or the system components are otherwise in communication internally with each other and/or externally with outside computing devices. Such a network may be any suitable network or combination of networks and supports any appropriate protocol suitable for communication of data to and from components of the device parameterization system 130. In some embodiments, the network may connect the components of the device parameterization system 130 with one or more external computing devices, including, but not limited to, one or more mobile devices. In some embodiments, the client terminal 133, server system 131, and/or any other component of the device parameterization system 130 not part of the device processing machines 132 may be located within the same facility as the device processing machines (e.g., within a local building such as a warehouse) or may be remote (e.g., cloud based or another facility).

According to various embodiments, the network 137 may include a public network (e.g., the Internet), a private network (e.g., a network within an organization), or a combination of public and/or private networks. According to various embodiments, the network is configured to provide communication between various components depicted in FIGS. 1-2. According to various embodiments, the network may comprise one or more networks that connect devices and/or components in the network layout to allow communication between the devices and/or components. For example, the network may be implemented as the Internet, a wireless network, a wired network (e.g., Ethernet), a local area network (LAN), a Wide Area Network (WANs), Bluetooth, Near Field Communication (NFC), Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or any other type of network that provides communications between one or more components of the network layout. In some embodiments, the network is implemented using cellular networks, satellite, licensed radio, or a combination of cellular, satellite, licensed radio, and/or unlicensed radio networks.

In various embodiments, the server system 131 may direct the datastore 134 to retrieve and/or transmit data via the network. In various embodiments, any data and/or executable code used in or useful for any of the embodiments discussed herein may be stored on the datastore 134. Hardware suitable for use as part of a datastore include all forms of non-volatile memory, media and memory devices, including by way of example, and without limitation, semiconductor memory devices, e.g., EPROM, EEPROM, and flash memory devices; magnetic disks, e.g., internal hard disks or removable disks; magneto-optical disks; and CD-ROM and DVD-ROM disks.

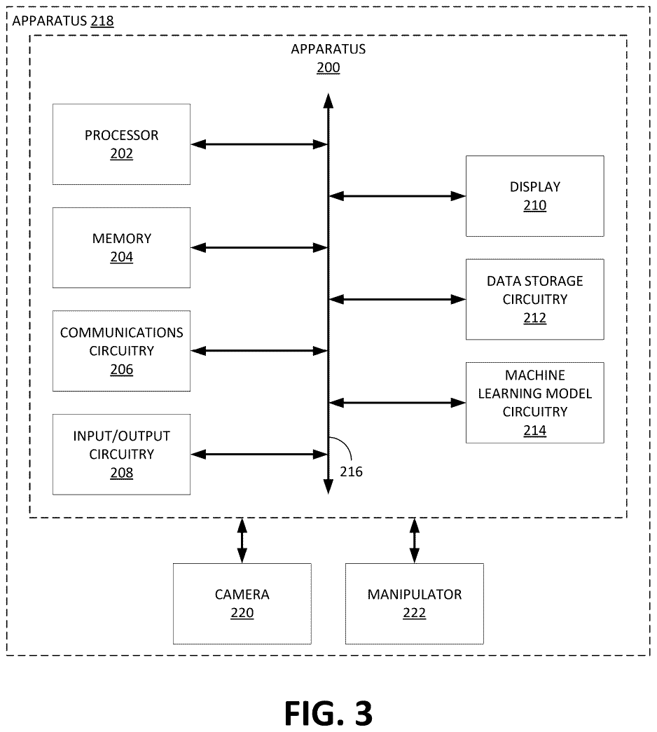

FIG. 3 illustrates a block diagram of an example apparatus 200 according to one or more described features of one or more embodiments of the disclosure. The apparatus 200 may represent, for example, a controller (e.g., controller 135 illustrated in FIG. 2), one or more apparatuses of the server system 131, or a user device embodying the client terminal 133, for example, configured to facilitate executing a device parameterization operation in accordance with at least some example embodiments of the present disclosure. A further apparatus 218 comprising hardware elements controlled by the initial apparatus 200 is also illustrated. For example, a device processing machine 132 may be represented by apparatus 218, and the device processing machine may include a controller 135 represented by apparatus 200 and additional hardware components, such as one or more cameras 220, manipulators 222 (e.g., robot arms, conveyors, etc.), and/or any other component described herein in association with specific device processing machines. In some embodiments, the apparatus 200 may include a processor 202, a memory 204, communications circuitry 206, input/output circuitry 208, display 210, data storage circuitry 212, and/or machine learning model circuitry 214 that are in electronic communication with one another via a system bus 216. In some embodiments, system bus 216 refers to a computer bus that connects these components so as to enable data transfer and communications between these components. Additionally, or alternatively, the apparatus 200 may be in other form(s) and/or may comprise other component(s). Various hardware components may be moved between the inner apparatus 200 and outer apparatus 218 or may be removed or moved externally in some embodiments.

In general, the terms computing device, system, entity, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein, including the aforementioned controller. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing system transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. In some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 206 provides network interface functionality to any of the sets of circuitry, and/or the like.

The processor 202 may be embodied in a number of different ways and may, for example, include one or more processing devices configured to perform independently. Additionally, or alternatively, the processor 202 may include one or more processors configured in tandem via a bus to enable independent execution of instructions, pipelining, and/or multithreading. Additionally, in some embodiments, the processor 202 may include one or processors, some which may be referred to as sub-processors, to control one or more components, modules, or circuitry of apparatus 200.

The processor 202 may be embodied as one or more complex programmable logic devices (CPLDs), microprocessors, multi-core processors, co-processing entities, application-specific instruction-set processors (ASIPs), and/or controllers. Further, the processor 202 may be embodied as one or more other processing devices or circuitry. The term circuitry may refer to a hardware embodiment or a combination of hardware and computer program products. Thus, the processor 202 may be embodied as integrated circuits, application specific integrated circuits (ASICs), field programmable gate arrays (FPGAs), programmable logic arrays (PLAs), hardware accelerators, another circuitry, and/or the like. As will therefore be understood, the processor 202 may be configured for a particular use or configured to execute instructions stored in volatile or non-volatile media or otherwise accessible to the processor 202. As such, whether configured by hardware or computer program products, or by a combination thereof, the processor 202 may be capable of performing steps or operations according to embodiments of the present disclosure when configured accordingly.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor to perform the algorithms and/or operations described herein when the instructions are executed.

In some embodiments, the memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the apparatus 200 to carry out various functions in accordance with example embodiments of the present disclosure. In this regard, the memory 204 may be preconfigured to include computer-coded instructions (e.g., computer program code), and/or dynamically be configured to store such computer-coded instructions for execution by the processor 202.

In an example embodiment, the apparatus 200 further includes a communications circuitry 206 that may enable the apparatus 200 to transmit data and/or information to other devices or systems through a network (such as, but not limited to, the datastore 134 as shown in FIG. 2). The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more circuitries, network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

In some embodiments, the apparatus 200 includes input/output circuitry 208 that may, in turn, be in communication with the processor 202 to provide output to the user and, in some embodiments, to receive an indication of a user input. The input/output circuitry 208 may comprise an interface or the like. In some embodiments, the input/output circuitry 208 may include a keyboard, a mouse, a joystick, a touch screen, touch areas, soft keys, a microphone, a speaker, or other input/output mechanisms. The processor 202 and/or input/output circuitry 208 may be configured to control one or more functions of one or more user interface elements through computer program instructions (e.g., software and/or firmware) stored on a memory accessible to the processor (e.g., memory 204).

In some embodiments, the apparatus 200 includes the display 210 that may, in turn, be in communication with the processor 202 to display user interfaces (such as, but not limited to, display of a call and/or an application). In some embodiments of the present disclosure, the display 210 may include a liquid crystal display (LCD), a light-emitting diode (LED) display, a plasma (PDP) display, a quantum dot (QLED) display, and/or the like.

In some embodiments, the apparatus 200 includes the data storage circuitry 212 which comprises hardware, software, firmware, and/or a combination thereof, that supports functionality for generating, storing, and/or maintaining one or more data objects associated with the device parameterization system 130. For example, the data storage circuitry 212 also stores and maintains data related to one or more parameterization operations in the datastore 134. In some embodiments, the data storage circuitry 212 may be integrated with, or embodied by, the datastore 134. In some embodiments, the data storage circuitry 212 includes a separate processor, specially configured field programmable gate array (FPGA), or a specially programmed application specific integrated circuit (ASIC).

In exemplary embodiments, the apparatus 200 includes machine learning model circuitry 214 which comprises hardware, software, firmware, and/or a combination thereof, that supports functionality for creating, training, updating, and/or maintaining one or more ML models according to various embodiments of the present disclosure. In various embodiments, the machine learning model circuitry 214 may work in conjunction with the processor 202 and the input/output circuitry 208 in order to create, train, update, and/or maintain the one or more models associated with the device parameterization system 130.

In some embodiments, two or more of the sets of circuitries 202-214 are combinable. Additionally or alternatively, in some embodiments, one or more of the sets of circuitry perform some or all of the functionality described associated with another component. For example, in some embodiments, two or more of the sets of circuitries 202-214 are combined into a single module embodied in hardware, software, firmware, and/or a combination thereof. Similarly, in some embodiments, one or more of the sets of circuitries, for example the communications circuitry 206, the data storage circuitry 212, and/or the machine learning model circuitry 214 is/are combined with the processor 202, such that the processor 202 performs one or more of the operations described above with respect to each of these sets of circuitries 206 and 212-214.

### Parameterization and Control Devices and Apparatuses

FIG. 4 provides an example functional block diagram of a server system 131 in accordance with some embodiments of the present disclosure. The functions depicted in FIG. 4 may be executed by the respective apparatuses illustrated in FIG. 3, for example, in some embodiments. As depicted, the server system 131 includes a translation framework 410 and a signal analysis framework 420. Server system 131 may be any system or device configured to control or otherwise manage operations associated with device processing parameterization.

As depicted, the server system 131 includes a translation framework 410 configured to process input commands (e.g., instructions) received from a user, such as via a terminal or other input device, either local to the server system 131 or located at an external device communication with the server system 131. The translation framework 410 may be embodied as an AI architecture in some embodiments (e.g., using one or more AI models 412a-d, collectively “412”, for various analyses as discussed herein). For example, the depicted embodiment includes four AI models We've described four possible AI models in your central server—two (or could be one) models 412b and 412d on the “instruction generation” side that create the code instruction sets for the machines (e.g., via generative AI) and two models 412a and 412c that analyze and translate the human inputs and signals from the machines, respectively, to generate computer-readable inputs and actionable data to the downstream instruction models. In some embodiments, rules-based models or other models may replace the depicted AI models. In some embodiments, two or more of the depicted models may be split or merged to perform collectively the functions described herein. In various embodiments, translation framework 410 is configured to receive instructions in natural language or as computer executable instructions, and translate them into instructions that are usable by the device processing machines 132 managed by the server system 131 by both generating instructions that are interpretable by the respective controllers of the device processing machines and by parsing the received instructions into individualized instructions (e.g., dynamic parameter updates) specific to the task to be performed by each respective device processing machine, such that one or more device processing machines receive instructions specific to their respective functions while, in aggregate, performing the function requested of the server system. For example, translation framework 410 may be configured to receive an instruction via a client terminal requesting that the device processing machines only process devices of a first model. The translation framework 410 may be configured to translate said instruction into an update to a device processing machine parameter, such that a controller configured to control the device processing machine may be updated a parameter of the device processing machine to reflect the changes of said instruction. For example, the translation framework 410 may be configured to extract key phrases or commands from the received instruction using a natural language processing layer 411 and correlate the key phrases or commands to configurable parameters using an instruction generation layer 413, which will translate said key commands into device processing machine parameters.

In some embodiments, the server system 131 may be configured to generate instructions to the respective device processing machines automatically without receiving a direct instruction from a user using a signal analysis framework 420. For example, in some embodiments, the server system 131 may be configured to receive operational data from one or more of the device processing machines 132 via an input layer 415. The operational data may be analyzed by a operational data analysis layer 416 detect an anomaly (e.g., anomalies such as electronic or cosmetic defects, underperformance, faults, error codes), which may include, but is not limited to, receiving and interpreting an error code, determining a fault or issue (e.g., a bottleneck) with one or more device processing machines, or detecting or otherwise identifying performance issues, other anomalies, or the like. Based on the received operational data signals relating to the performance of the device processing machines, the server system 131 may be configured to generate instructions using an instruction generation layer 418 configured to reconfigure the device processing line system to resolve the issue (e.g., take a device processing machine offline for maintenance) or improve line performance in light of the issue (e.g., directing a portion of the analyzed devices to other device processing machines to balance the workload via reconfiguring the conveyors and/or other upstream machines). Both the translation framework 410 and signal analysis framework 420 may then transmit the instructions to the respective device processing machines, such as via the depicted output layer 422.

As depicted, the translation framework 410 includes at least one AI model 412a, b (e.g., one or more machine learning based data analysis models configured to perform the functions described herein). In at least some embodiments, AI model(s) 412 a, b may be one or more machine learning models trained according to a set of training instructions and corresponding parameter updates, and such a trained model may then determine parameter updates responsive to receiving user commands via a client terminal or other terminal operably connected to the server system 131. In some embodiments, an input translation AI model 412a may be used to parse the user input commands (e.g., natural language processing or otherwise deciphering the input commands) to translate the user input commands into a machine interpretable form configured to be input into the instruction generation layer 413. The instruction generation layer 413 may then, for example, use an instruction AI model 412b to generate the machine instruction set configured to be transmitted to the respective device processing machines. In some embodiments, a rules based model may be used in addition to or instead of one or both AI models 412a, b (e.g., to generate the respective parameter updates to the dynamic processing machines in addition to or instead of an AI-based model). In some embodiments, the translation framework 410 includes a mapping (e.g., a predetermined mapping at the instruction generation layer 413) from one or more input commands, including terms, operations, and the like to one or more device processing machine parameters. While the translation framework 410 is depicted as being performed by the server system 131, at least some operations of the translation framework 410 may be executed at the client terminal and/or device processing machine level in some embodiments. For example, in some embodiments, the client terminal may include natural language processing software configured to generate an intermediate set of computer-executable instructions that are then translated further by the server system as described herein.

Translation framework 410 may include an input module 414 via which parameters or instructions may be provided to and received by the translation framework 410. In at least some embodiments, natural language processing layer 411 (e.g., via AI model 412) may be configured to apply natural language processing (NLP) techniques to a received command to process said command and the translation framework 410 may subsequently generate machine-readable instructions configured to be transmitted to the respective device processing machines 132. The instruction generation layer 413 (e.g., via AI model 412b) may subsequently generate individual device processing machine level instructions (e.g., dynamic parameter updates) for the respective device processing machines based on the machine-readable instructions. In at least some embodiments, the instruction AI model 412b may be configured for one or more generative AI operations, such that the received input, received instructions, received commands, etc. may be received as human-readable text commands which are subsequently translated via generative AI into computer-executable code. The generative AI model may operate in accordance with the various AI processes described herein (e.g., as a transformer neural network in a nonlimiting example).

In at least some embodiments, the translation framework 410 may be configured to translate a plain, natural language command such as “prioritize device model A” into instruction sets capable of modifying the operational state of one or more device processing machines. For example, translation framework 410 may translate a “prioritize device model A” command into a machine-readable instruction set configured to lower the grading threshold for refurbishment of device model A (e.g., increasing the number of devices retained for resale, refurbishment, and/or reuse, rather than being recycled or otherwise disposed of) for a first device processing machine, a machine-readable instruction set configured to screen out and hold devices which are not of model A for a second device processing machine, a machine-readable instruction set configured to turn off/bypass devices of model A (e.g., reduce processing steps to deliver devices of model A more rapidly) for a third device processing machine, and/or a machine-readable instruction set configured to forward devices of model A to the shipping area for a fourth device processing machine. In at least some embodiments, translation framework 410 is configured to translate a user issued plain text/plain language or general computer code command into a specific computer code instruction set for each of one or more corresponding devices as described herein.

As depicted, the server system 131 may additionally or alternatively include a signal analysis framework 420. The signal analysis framework 420 may be configured to handle automated control functionality responsive to various inputs without requiring, although not precluding client input. For example, signal analysis framework 420 may be configured to issue an instruction to revert a device processing machine parameter back to a previous state responsive to determining that a period corresponding to an updated parameter has expired or responsive to detecting an anomaly, such as failure of the device processing machine via error code or lack of expected signal from the device processing machine.

The signal analysis framework 420 may be configured to receive machine status information in the form of operational data at an input layer 415. The operational data may correspond to one or more device processing machines such that the signal analysis framework 420 may detect an operational malfunction or other problem or need for improvement or modification with a device processing machine, and the signal analysis framework 420 may redirect device processing away from the subject machine. In at least some embodiments, the signal analysis framework 420 may be configured to analyze data related to a device processing machine and the devices processed by said machine, and may subsequently be configured to update parameters responsive to certain detected conditions. For example, the signal analysis framework 420 may be configured to determine (e.g., via an operational data analysis layer 416) that a device processing machine is not processing any devices (e.g., if the machine is currently configured to only process devices of a first model and there may not be any such devices remaining in the device line, for example). In such an embodiment, the signal analysis framework 420 may be configured to automatically update (e.g., via an instruction generation layer 418 and output layer 422) the device processing machine to instead process one or more additional device types, as processing some devices of a lower priority may be more efficient than processing few to zero devices of a higher priority while other device processing machines are bottlenecked with the lower priority devices. In at least some embodiments, the signal analysis framework 420 may be configured to receive one or more client instructions (e.g., via input layer 415 similar to the translation framework 420) regarding how to re-parameterize a device processing machine responsive to detecting an outlier condition with respect to a device processing machine and/or a group of devices to be processed. Such instructions may be pre-stored or decided in real time. In some embodiments, the server system 131 may be pre-programmed with response instruction sets for one or more various status signals associated with the various device processing machines, the server system, and/or the client terminal.

The operational data analysis layer 416 may comprise a performance analysis AI model 412c which may be trained (e.g., using structured or unstructured learning as discussed herein) to detect one or more issues, anomalies, or the like in the operational data configured to trigger a subsequent instruction to update one or more dynamic parameters. In some embodiments, the performance analysis AI model 412c may generate a prediction of a throughput or other metric capable of being realized by one or more alternative configurations of dynamic parameters for one or more device processing machines 132. In an instance in which the predicted alternative throughout or other metric exceeds the current throughput or corresponding metric of the device processing line, or a exceeds threshold above the current throughput or corresponding metric, the signal analysis framework 420 may trigger the update. In some embodiments, rules-based models may be used in addition to or instead of the performance analysis AI model 412c. Similar to the instruction generation layer 413 of the translation framework 410, the instruction generation layer 418 of the signal analysis framework 420 may be configured to generate a machine instruction set configured to add or update dynamic parameters of one or more of the device processing machines to accomplish the update process determined by the operational data analysis layer 416. The instruction generation layer 418 may utilize an instruction AI model 412d or another model for generation the machine instruction set similar to the instruction generation layer 413 of the translation framework 410.

In some embodiments, the signal analysis framework 420 may be configured to detect new device processing machines added to the device processing line (e.g., via detecting connection of an unknown device processing machine being added to the local network or another explicit or implicit trigger signal), and the signal analysis framework 420 may onboard and configure the dynamic parameter of the new device processing machine and/or update the operational states of one or more other device processing machines already on the line to optimize performance while accounting for the new device.

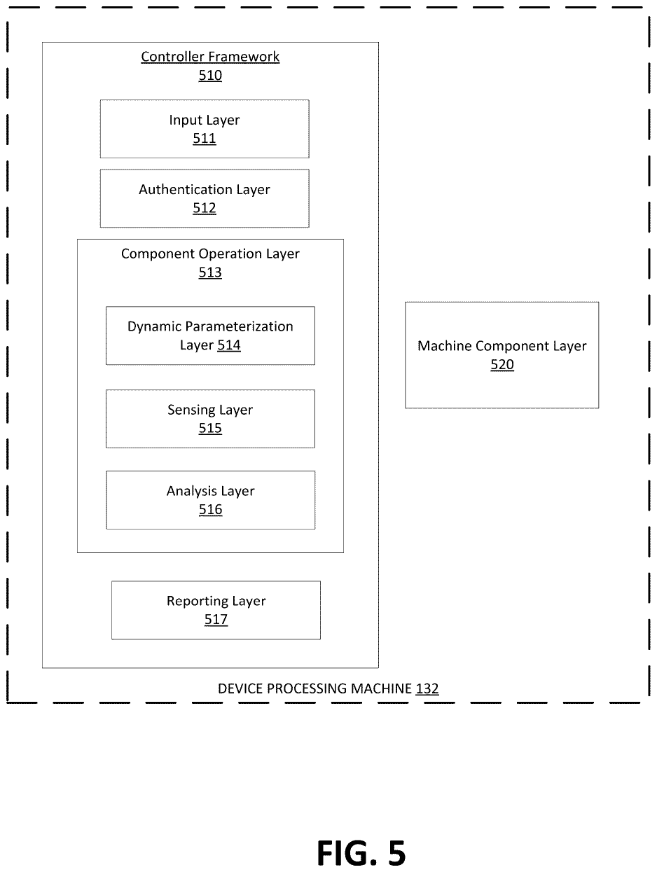

FIG. 5 provides an example functional block diagram of a device processing machine 132 in accordance with some embodiments of the present disclosure. As depicted, device processing machine 132 includes controller framework 510 and machine component layer 520. Device processing machine 132 may be configured to process devices (or other objects) according to one or more dynamic parameters as provided by, for example, a server system 131. As discussed herein, prior to accepting remote, centralized control from the server system 130, the device processing machine 132 may be modified to include the dynamic parameter, enabling the dynamic parameterization layer 514 described herein. Following parameterization of the controller, the device processing machines 132 may be configured to be programmable and reprogrammable remotely by external devices, such as the server system 131. The device processing machines 132 may execute the respective functions of the various machines described herein and any other machine that may be used for processing one or more objects.

Controller framework 510 may be configured to control operations of the device processing machine 132 based upon its programmed parameters, including the at least one dynamic parameter configured to permit modification of the controller of the device processing machine's code (e.g., making the controller of the device processing machine remotely writeable) in response to commands from the server system 131 (e.g., in some embodiments, via the int and listener functionality described herein). The controller framework 510 may include an input layer 511 configured to receive machine instructions (e.g., from the server system 131). An authentication layer 512 may be configured to authenticate any received communication providing operations or instructions regarding the operation of the device processing machine 132, including authenticating each machine instruction from the server system 131. In at least some embodiments, authentication layer 512 is configured to determine whether a device communicating operations or instructions (e.g., the server system 131) is authorized to provide such instructions. For example, authentication layer 512 may be configured to verify that the instructions are received via a corresponding server system 131, which is authorized to control the device processing machine(s) 132. In at least some embodiments, authentication layer 512 may be configured to confirm whether a client device (or a user account identified in association with the instructions or client device) providing instructions to the server system 131 is authorized to update the device processing machine parameters. In some embodiments, the server system 131 is configured to reject parameter instructions from devices which are not authorized to provide such instructions, and therefore authentication layer 512 may not be required to authorize client devices accordingly. Authentication layer 512 may further be configured to confirm that received operations or instructions were provided by an authorized user of a server system 131 and/or a client terminal 133. In at least some embodiments, authentication layer 512 is configured to verify a certificate at the client side and/or the server side.

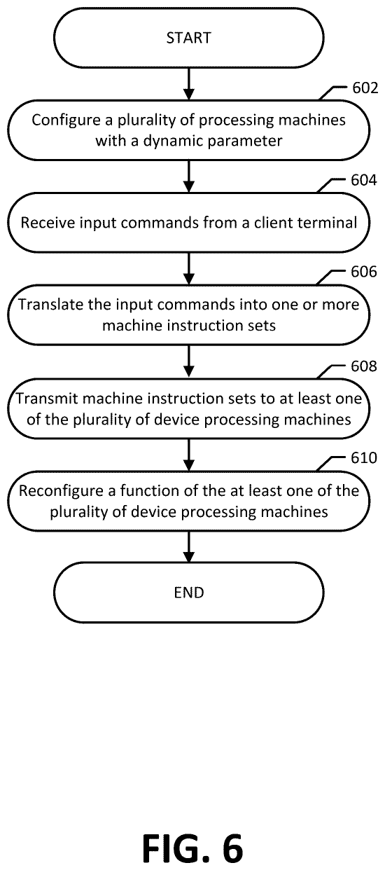

The controller framework 510 may further include a component operation layer 513 configured to generate signals to operate the various components of each device processing machine, which are represented in FIG. 6 by the machine component layer 520. The component operation layer 513 may be configured to deliver electrical energy or other control signals to the various components of the device processing machines as discussed herein (e.g., control the robotic arms, cameras, conveyors, and the like). The component operation layer 513 may further include a dynamic parameterization layer 514 and a sensing layer 515. The dynamic parameterization layer 514 may be configured to receive instructions corresponding to one or more operations of the device processing machine 132 and update the component operation layer 513 according to the new operational state. In at least some embodiments, dynamic parameterization layer 514 is configured to receive instructions which have been translated into parameterized instructions by the server system 131 and set the corresponding values in the component operation layer 513 to configure the device processing machine 132 to operate as instructed. The dynamic parameterization layer 514 may be configured to update one or more machine parameters according to the machine instructions to control operation of one or more components of the machine component layer 520. In at least some embodiments, the machine parameters define operation of one or more components of the machine component layer 520.

The sensing layer 515 may capture various signals associated with the operation of the device processing machine 132 including device level data such as storing a count of each device the passes through the device processing machine, the operations performed on the device, and the time to process the device. The sensing layer 515 may additionally or alternatively capture component or signal level data, such as the voltage and power drawn by each component, any errors generated by any components, including the controller, and the like. The sensing layer 515 may also receive and analyze signals from sensors placed in various locations about the device processing machine (e.g., temperature, moisture, etc. sensors). An analysis layer 516 may be configured to perform various data analysis processes of the device processing machine 132, including processes related to the primary function of the machine, like image analysis and grading, as well as internal functions such as error detection. The component operation layer 513 (e.g., via the sensing layer 515 and/or analysis layer 516) may be configured to report these various datum as operational data back to the server system 131 using a reporting layer 517.

Machine component layer 520 may include one or more components configured to execute actions required for device processing. In general, machine component layer 520 includes any devices, device components, system elements, and the like which are leveraged for device processing operations, such as determining a device make, model, condition, and the like. Machine component layer 520 may include any number of hardware components configured for analyzing a subject device.

Each of the various functions describe with respect to FIGS. 4-5 may be performed by the apparatuses shown and described herein, such as the system 100, 130 components shown in FIGS. 1-2 and the apparatuses 200, 218 shown in FIG. 3.

### Example Processes of the Disclosure

FIG. 6 illustrates a flowchart representing a process 600 for parameterizing and centrally controlling one or more device processing machines in accordance with one or more embodiments of the present disclosure. In various embodiments, process 600 may be executed by a device processing system comprising a server system 131 and a device processing machine 132, for example. In general, process 600 may be executed by any system configured to manage device processing machines which operate according to a set of parameters using controllers (e.g., PLCs), including but not limited to those that filter, process, sort, or otherwise manage devices (such as mobile devices).

Process 600 may begin at operation 602. At operation 602, device parameterization system 130 configures a plurality of processing machines with a dynamic parameter. In at least some embodiments, configuring a device processing machine with a dynamic parameter comprises a newly defined variable type comprising an int and a corresponding listener such that the corresponding processing machine is capable of receiving and executing remote code updates. For example, the variable listener is configured to receive instruction sets corresponding to the associated int such that said int may be changed from a current value to a requested value. In at least some embodiments, the plurality of processing machines may additionally be configured with an authentication function, such that the processing machine (or a controller of the processing machine) may authenticate a device issuing a parameterization request before making changes responsive to the request. Each possible value of the int may be associated with a corresponding operational state or state defining one or more operations of the corresponding device processing machine. Operation 602 may be performed by a programming device configured to directly interface (e.g., via USB, serial, ethernet, or similar wired connection) with the respective device processing machines to configure the dynamic parameter. Following configuration, the device processing machines may then be remotely writeable to enable centralized control.

At operation 604, device parameterization system 130 receives input commands, such as from a client terminal. In at least some embodiments, the client terminal may be associated with an external client device via which a user may communicate with a server system of the device parameterization system 130, while in other embodiments, the client terminal may be implemented directly via the server system itself. In general, the client terminal may be implemented via any device that is both capable of and authorized to communicate with a server system and/or a device processing machine of device parameterization system 130.

At operation 606, device parameterization system 130 translates the input commands into one or more device processing machine instruction sets. This operation may include the various processes shown and described in relation to FIGS. 4-5 using the various systems and apparatuses of FIGS. 1-3. In various embodiments, device parameterization system 130 is configured to apply one or more trained machine learning models to the received input commands to determine one or more corresponding device processing machine instruction sets in a format usable by the device processing machine. The machine learning models may be trained using a set of training input commands and a corresponding set of device processing machine instruction sets (e.g., structured learning via labeled data), such that the machine learning model may identify associations between terms of the input commands and various instruction sets implemented at the device processing machine level. In at least some embodiments, device parameterization system 130 is configured to provide the translated instruction sets to a controller of a device processing machine. The translated instruction sets may be provided in a format indicating one or more changes to device processing machine parameters. In at least some embodiments, the device processing machines are configured with an int and a corresponding listener, such that the machines are configured to receive remote instruction sets updating the corresponding variable. The device processing machines may each listen for commands over one or more networks, which commands may be coded to the individual device processing machines. Similarly, as discussed herein, each device processing machine may periodically report its status to the network for receipt and analysis by the server system.

In at least some embodiments, translating the input commands into one or more device processing machine instruction sets comprises using one or more generative artificial intelligence models or functions to create machine readable instructions corresponding to the input commands. In such embodiments, the generative AI models may be configured to train and utilize neural networks (e.g., transformer neural networks) to identify patterns in previously implemented input command/machine instruction set pairings to inform generation of new and original instructions corresponding to newly received commands. For example, the AI models, such as instruction AI models 412b, d shown in FIG. 4, may be configured to use a deep learning architecture (e.g., a transformer neural network) to generate the instruction set for each of the device processing machines based on the input commands (e.g., as translated by the natural language processing layer 411) and/or signals received from the device processing machines (e.g., via operational data analysis layer 416). In an example embodiment, the input signals may be fed as a source sequence into an encoder of the transformer neural network to generate the transformer. The transformer may use positional encoders to add context to the input sequence, generating a final input matrix to the encoder. The encoder may use a multi-head attention mechanism to create a matrix of the attention vectors for each word in the input. The attention vectors may be passed to a feed forward neural network to transform the attention vectors to generate encoded vectors for each input vector.

The transformer may receive, in a decode side of the architecture, an example instruction set comprising the code generated for each device processing machine, which may also undergo positional encoding and embedding, transforming the inputs into respective vectors similar to the encoder side. A masked multi-head attention block may then generate attention vectors for each word/value of the instruction set input sequence. The resulting attention vectors from the encoding side may be passed into another multi-head attention block (e.g., an encoder-decoder attention block), where the input sequence is mapped to the output sequence to generate attention vectors for every input and output, with each vector showing the relationship between inputs and outputs. Passing each resulting vector into a feed-forward neural network, linear layer, and/or SoftMax layer may produce a final probability distribution mapping the inputs to a predicted output. The generative AI model may thereby be trained to generate machine instruction sets (e.g., comprising one or more dynamic parameter updates) in response to the various inputs described herein.

At operation 608, device parameterization system 130 transmits one or more instruction sets to at least one of the plurality of device processing machines. In at least some embodiments, device parameterization system 130 is configured such that the device processing machines receive the transmitted one or more instruction sets in parameter format; in other words, the received instruction sets may indicate changes to a device processing machine parameter(s). In at least some embodiments, each device processing machine parameter configures the corresponding machine into one of a plurality of operational states and/or one or more features of an operational state (e.g., configures one or more variables or inputs of a corresponding operational state, such as a make or model for prioritization). The device processing machines may be programmed with parameters corresponding to a plurality of operational states, wherein each operational state dictates a set of machine operations to be executed. For example, a first mode may be configured to process only devices corresponding to a first model or make, while a second mode may be configured to process only devices above a certain quality threshold.

At operation 610, device parameterization system 130 automatically reconfigures a function of at least one of the plurality of device processing machines consistent with the updated operational state and/or the updated feature of the operational state. In various embodiments, device parameterization 130 automatically configures the at least one device processing machine according to the updated operational state. For example, for a first example operational state configured to process only devices corresponding to a specific model, the at least one device processing machine is configured to filter devices according to specifications of the specific model. Similarly, for a second example operational state configured to process only devices above a certain quality threshold, the at least one device processing machine is configured to filter devices according to specifications associated with the defined quality threshold, such as screen condition, button condition, scrapes and scratches on the body of the device, and the like. The instructions from the server system may be configured to cause the device processing machine to update the operational state.

In at least some embodiments, the system may be configured to connect a new device processing machine into the device parameterization system 130 and integrate the machine into one or more existing workflows. Device parameterization system 130 may be configured to define one or more parameters for the new device processing machine such that the new device processing machine may be remotely written and configured in accordance with one or more instruction sets. In at least some embodiments, the new device processing machine is configured with a new variable in its code that includes an int and a listener as described herein, such that said variable may be remotely updated.

In at least some embodiments, device parameterization system 130 is configured to modify an existing device processing machine to add a new variable to its existing code that enables the device processing machine to have its code written remotely, such that the operational states may be updated from the server system. The authentication functions described herein may then further ensure the security of the system once such functionality is implemented.

In at least some embodiments, device parameterization system 130 configures a plurality of device processing machines to meet a set of requirements as indicated by the received instructions. For example, if the received instructions indicate a desired distribution of devices for processing (such as 70% a first model and 30% a second model, for simplicity of example), the device parameterization system 130 may be configured to send parameter update instructions to a first set of the device processing machines (collectively responsible for 70% of device processing, for example) to process devices of the first model. The device parameterization system 130 may be configured to send different parameter update instructions to a second set of the device processing machines (collectively responsible for 30% of the device processing, for example) to process devices of the second model.

In at least some embodiments, device parameterization system 130 may be configured to monitor the performance of the device processing machines. In such embodiments, performance may be monitored according to reports received from the device processing machines themselves, or according to reporting data indicating throughput metrics corresponding to the devices being provided, processed, or analyzed via the corresponding device processing machines. Device parameterization system 130 may further be configured to provide a real-time display of current operational metrics of the device processing machines. For example, in the aforementioned example, if the 70% threshold on the first model is reached first or is predicted to be reached first, the system server may send (e.g., automatically without further instruction sets in some embodiments) to the first set of device processing machines to remedy the predicted overage (e.g., via slowing down the first set of device processing machines, reallocating at least a portion of the first set of device processing machines to the second set, and/or directing the first set of device processing machines to process other devices).

In at least some embodiments, device parameterization system 130 may be configured to automatically determine appropriate updates for the device processing machines. For example, in an embodiment where the monitored performance of the device processing machines indicates that a machine which had been configured to prioritize devices of a model A is currently malfunctioning, not operating, not responsive, or no status signal is received, the device parameterization system 130 may automatically push an instruction to one or more additional device processing machines to prioritize devices of the model A to compensate for the broken machine. The device parameterization system 130 may additionally send a repair request responsive to identifying the malfunctioning machine (e.g., a repair request to a client terminal), which may include shutting down the malfunctioning machine until the repair is indicated complete or the repair request is otherwise dismissed. It should be appreciated that, while the above embodiments describe issuing updates responsive to a malfunction, for example, such updates may be automatically issued in the presence of properly functioning machines responsive to other conditions, such as detected channel conditions or other factors which may impact demand for certain devices (such as a new device release, for example) or detected inventory conditions such as an overstock of devices of a certain make or model.

In at least some embodiments, device parameterization system 130 may be configured to manage device processing machines which do not exhibit identical functionality as discussed herein, with two or more of the various device processing machines performing different functions along the device processing line 100 (e.g., the device processing line 100 shown in FIG. 1). In such embodiments, a first set of device processing machines may process devices of a first make or model faster than it processes other devices; as such, device parameterization system 130 may be configured to automatically configure the first set of device processing machines to handle as much processing of devices of the first make as possible to best leverage the device's efficiency when processing such devices. The device parameterization system 130 (e.g., via system server 131) may be configured to detect and analyze the relative performance of the various device processing machines across any variables, including but not limited to make and model, to thereby calculate the optimal operational states of the respective machines to maximize throughput of the device processing line consistent with the input commands and other parameters of the device parameterization system 130.

In at least some embodiments, device parameterization system 130 refers to a system distributed amongst a single processing location (such as a warehouse). In other embodiments, device parameterization system 130 may include devices distributed across a plurality of processing locations, such that any requested device processing distributions are determined and achieved collectively across the distribution of devices. In such embodiments, a first processing location may report a performance issue with respect to one or more processing devices, and a second processing location may be automatically configured to account for the potential issues at the first processing location. In some such embodiments, logistics devices, such as transportation equipment, may be included in the device processing machines.

In at least some embodiments, device parameterization system 130 is further configured to monitor one or more market conditions via one or more market data sources. For example, device parameterization system 130 may be configured to monitor device sales data to determine demand corresponding to one or more subject devices. In such embodiments, device parameterization system 130 may be configured to push updates to one or more device processing machines according to analyses generated in response to the monitored device sales data. Further, device parameterization system 130 may be configured to predict demand based on additional device information, such as a notification that a new device from a first make is being released soon, potentially influencing demand for older models from said first make. As such, device parameterization system 130 may analyze sales data corresponding to previous device releases from the first make, and may configure the device processing machines to process devices according to that predicted demand. For example, if device parameterization system 130 determines that device releases from the first make have historically driven increased sales of older models from the first make, device parameterization system 130 may issue parameter updates instructing device processing machines to prioritize devices from the first make. Alternatively, if device parameterization system 130 determines that device releases from the first make have historically led to decreased sales of other models from the first make, device parameterization system 130 may issue parameter updates instructing device processing machines to de-prioritize devices from the first make.

In at least some embodiments, device parameterization system 130 is further configured to receive feedback from one or more device processing machines. For example, in an embodiment where the device processing machines begin receiving devices for processing which do not correspond to devices for which make, model, or other identifying information are known, the device processing machines may provide feature information to the device parameterization system 130 such that device parameterization system 130 may determine a corresponding device.

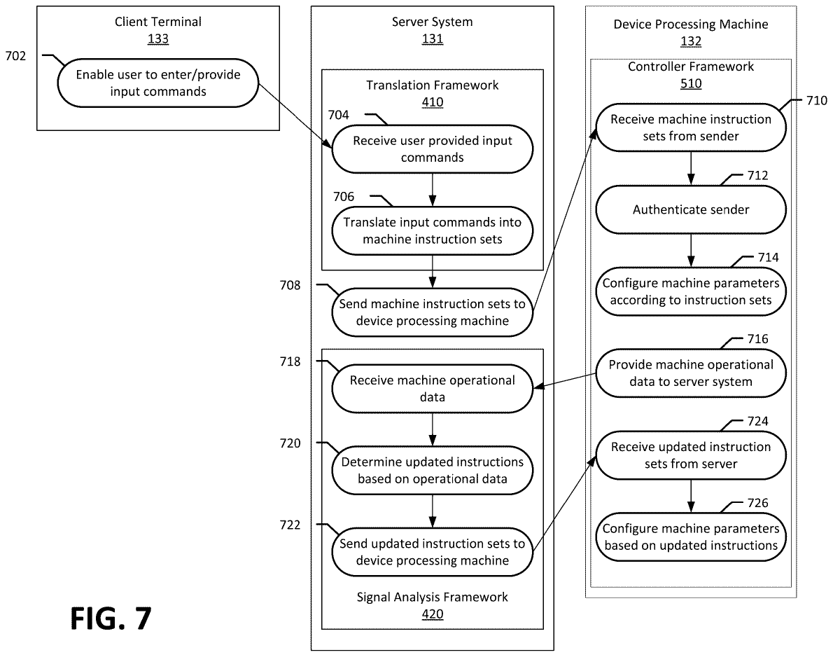

FIG. 7 illustrates a flowchart representing a process 700 as executed by a client terminal 133, a server system 131, and at least one device processing machine 132. As depicted, process 700 includes enabling (702) a user to enter or provide input commands via the client terminal 130, receiving (704) the user provided input commands at the one or more apparatuses of the server system 101, translating (706) the input commands into machine instruction sets for the one or more device processing machines 102, sending (708) machine instruction sets to the one or more device processing machines 102, receiving (710) the machine instruction sets from a sender at the one or more device processing machines 102, authenticating (712) the sender of the machine instruction sets at the one or more device processing machines 102, and configuring (714) machine parameters according to the instruction sets after which the device processing machine(s) 102 may operate in accordance with the operational state defined by the instruction sets. In some embodiments, the process 700 may include the device processing machine(s) continually and/or periodically providing (716) machine operational data (e.g., data including throughput, sensor readings, anomalies such as electronic or cosmetic defects, underperformance, faults, error codes, or the like) to the server system, receiving (718) machine operational data from the device processing machine(s) at the server system 131, determining (720) updated instructions based on the operational data via the server system 131, sending (722) updated instruction sets to the device processing machine, receiving (724) the updated instruction sets from the server system at the device processing machine(s) (including, in some embodiments, different machines than the one whose operational data triggered the update in addition to or instead of updating the machine that triggered the update), and configuring (726) machine parameters based on the updated instructions at the one or more device processing machines. Process 700 may provide cloud-based management of the functioning of one or more device processing machines via a server system and a client terminal.

An example description of the process 700 steps is now described. The description of the steps is exemplary and may be modified in various embodiments, including but not limited to moving certain process steps to be performed on different devices, adding or removing process steps, or the like. At operation 702, client terminal 133 enables a user to enter or provide input commands. In at least some embodiments, client terminal 133 is an interface associated with a computing system including one or more displays and/or input devices (e.g., touchscreen displays, microphones, keyboards, cameras, etc.) via which a user may configure and otherwise create one or more input commands corresponding to a device processing environment. In at least some embodiments, client terminal 133 corresponds to an interface displayed via an authorized user device, for example, via which the user may provide the input commands. In at least some embodiments, enabling a user to provide input commands includes providing a set of one or more selectable commands which the user may choose from. For example, the selectable commands may include prioritizing (or deprioritizing) devices of a certain make or model, increasing or decreasing throughput of a certain device model or make, adjusting one or more threshold parameters for one or more actions of the device processing machine, and the like. In at least some embodiments, enabling a user to provide input commands includes enabling the user to provide verbal or text-based commands indicating their commands. The client terminal and/or server system may be configured to translate natural language inputs such that the user may intuitively interact with the device processing system and issue commands that reconfigure the device processing lines in response to the inputs.

At operation 704, server system 131 receives the user provided input commands from the client terminal 133. In at least some embodiments, the server system 131 receives the user provided input commands from the client terminal 133 via one or more transmissions via a network. In at least some embodiments, the server system 131 and the client terminal 133 are operably connected, such that the input commands are received by the server system 131 via a dedicated channel, for example. The user provided input commands may be directly received by a translation framework 410 of the server system 131.

At operation 706, server system 131 translates the user provided input commands into one or more machine instruction sets. In at least some embodiments, server system 131 is configured to use one or more machine learning techniques to translate the user provided input commands into machine instruction sets. For example, server system 131 may leverage natural language processing (NLP) techniques to identify one or more keywords and/or functions as indicated by the user provided input commands. In such embodiments, the server system 131 may be configured to identify machine instruction sets corresponding to the identified keywords and/or functions. In at least some embodiments, the identified machine instruction sets may be tagged with one or more keywords to facilitate identification. In various embodiments, the server system 131 may be configured to store machine instruction sets as historically applied responsive to previously executed commands. In such embodiments, the server system 131 may query the stored machine instruction sets and corresponding previously executed commands to generate a prediction of the correct command corresponding to the natural language input by identifying one or more most similar (e.g., via a confidence score) previously executed commands in the training data using a trained artificial intelligence (e.g., machine learning) model trained on the training data. In some embodiments, the server system may store machine instruction sets as historically applied responsive to previously executed commands or template instruction sets generated independently of historical operations. In some embodiments, the server system may perform a rules-based analysis to identify the historical instruction set or template instruction set matching the input command (e.g., with or without natural language processing). Identifying a most similar previously executed command and/or template command with respect to the user provided input commands may include using natural language processing techniques to identify commands which correspond to the same or similar keywords; for example, in scenarios where no exact match for the user provided input commands exists among the previously executed commands, server system 131 may be configured to identify one or more previously executed commands directed towards similar or synonymous keywords. As depicted, server system 131 may include a translation framework configured to translate the user provided input commands into one or more machine instruction sets.

Translating (706) the input commands into machine instruction sets may include identifying one or more machine operations which must be enabled, disabled, or otherwise adjusted to accommodate the user provided input commands and generating one or more specific machine instructions to execute the respective operation modifications. For example, if a user provided command directs the server system to throughput devices of a first model regardless of condition, the server system 131 may translate said commands into machine operations instructing device processing machines to cease filtering analyzing the condition of devices of the first model, and strictly pass all devices of the first model through. In some embodiments, the individual device processing machine commands may be generated as a result of the above-referenced analysis using the previously executed historical commands and/or template commands (e.g., a single user input may be mapped to each of the machine specific outputs). In some embodiments, the individual device processing machine commands may be generated as a subsequent step following the identification of a machine interpretable command generated as a result of the above-referenced analysis using the previously-executed historical commands and/or template commands (e.g., a single user input may be mapped to one or more system-level commands after which the system may subsequently generate individual device processing machine commands). In the latter example, the second step of generating the individual device processing machine commands may be carried out using a second version of the aforementioned historical and/or template command analysis, may use a rules-based analysis based on a predetermined function and variables assigned to each device processing machine, or may use another method of mapping the translated user input to the individual device processing machine commands. In another example, if a user provided command directs the server system to reduce the number of top-grade devices of a particular make and/or model or to raise a condition threshold for passing devices of a first make or model through, the server system 131 may translate said command into machine operations instructing device processing machines to raise a condition parameter from a 5/10 to a 7/10 (for a simple condition scale graded from 1 to 10, for example) such that devices whose screen falls below a 7/10 rating will be filtered out. In some embodiments, the same initial command may cause additional cosmetic screenings to be performed by different device processing machines or other permutations of device processing machine instructions that may carry out the user input command. The final instruction set may depend on both the available training data, command mappings, rules sets, and the like as well as on the available device processing machines, the status and availability of which may remove one or more possible instruction sets from the process. For example, in some embodiments, the server system 131 may generate a ranked list of device processing machine instructions or a ranked list of full device processing machine instruction sets and the ultimate set that is executed may be the highest ranked option for which all available device processing machines needed to carry out the instruction set are available for instruction. In some embodiments, the server system 131 may only analyze possible device processing instructions or full sets of device processing instructions that the current device processing line is capable of executing. In general, translating the input commands into machine instruction sets includes identifying one or more parameterized operations of corresponding device processing machines that affect functions which contribute to the user provided command and generating device-specific instructions that update the corresponding parameters of the device processing machine to execute the instruction.

In at least some embodiments, translating (706) the input commands into machine instruction sets includes identifying one or more operating modes corresponding to the input commands. An operating mode may be one or more predefined parameter values of a corresponding device processing machine, wherein the parameter values influence one or more operations of the device processing machine. A device processing machine may be configured with one or more parameters dictating the device processing machine's operation; for example, a controller of a device processing machine may be configured with a writable variable and a set of corresponding variable definitions, such that each writable value corresponding to the variable instructs the device processing machine to operate in a defined mode. For example, if a device processing machine is configured to conduct three operations, writable states of the corresponding parameter may be defined to enable/disable each of the three operations in each available combination. Further, writable states of the corresponding parameter may be defined with considerable granularity, such that states of the variable further indicate one or more parameters of each of the three operations. Using a first operation configured for screen condition analysis as an example, a first parameter state may indicate that the first operation is enabled, a second parameter state may indicate that the first operation is disabled (thus, all devices are throughput regardless of screen condition), a third parameter state may indicate that a threshold for throughput/filtering is set to a first threshold level, a fourth parameter state may indicate that a threshold for throughput/filtering is set to a second threshold level, and so on. A parameter may have any number of defined states corresponding to any number of operational states for the subject machine. Further, a subject machine may have a plurality of parameters, each corresponding to an operation of the subject machine. For example, if a machine is configured to execute two operations, the machine may have two writable parameters, each configured to inform execution of one of the two operations.

In at least some embodiments, the machine instruction sets may include instructions for configuring throughput routing as managed by a device processing machine. For example, a device processing machine may be configured to route devices to a first location subsequent to first analysis result or a second location subsequent to a second analysis result. The machine instruction sets may be configured to alter (i) the functioning of the mechanisms configured for routing the devices or (ii) the parameters dictating when a device is sent to each location. For example, the machine instructions may change the terms under which a device is sent to a first conveyor belt rather than a second, or the terms under which flaps obstructing a first conveyor belt are opened, etc. The machine instructions may change the parameter values which dictate when a device is sent to each location as well. As suggested above, the routing parameter may be an additional function of one or more device processing machines that handle another, primary function in the device processing line (e.g., an outfeed conveyor or robot arm function of a visual inspection machine). Additionally or alternatively, dedicated routing device processing machines (e.g., carts, robots, conveyors, or the like) may be controlled in substantially the same manner to direct objects from specified machines to other specified machines in accordance with one or more operational states thereof.

At operation 708, server system 131 sends machine instruction sets to one or more device processing machines 132. In at least some embodiments, sending machine instruction sets to one or more device processing machines includes transmitting, via a network, the machine instruction sets corresponding to the user provided input commands. In various embodiments, server system 131 is configured to send a first subset of the machine instruction sets to one or more device processing machines of a first type. In such embodiments, server system 131 is configured to send a second subset of the machine instruction sets to one or more device processing machines of a second type. In some embodiments, the server system 131 may broadcast the device processing machine instruction set across a network (e.g., local area network) with identifiers indicating the recipient device processing machine of each instruction. In such embodiments, the machine instruction sets indicate one or more changes to machine parameters directly. In other embodiments, the machine instruction sets indicate one or more operational states corresponding to one or more affected device processing machines. In some embodiments, each device processing machine may store one or more operational states locally, such as by a designation (e.g., Mode A, Mode B, Mode C, etc.), and the transmitted instruction may indicate the mode in which to operate.

At operation 710, the device processing machine 132 (e.g., a controller framework 510 of the device processing machine 132) receives the machine instruction sets from the sender. Receiving (710) the machine instruction sets from a sender may include receiving a network transmission comprising one or more machine instruction sets from the server system 131 as described above with respect to operation 708. In at least some embodiments, the machine instruction sets include one or more defined changes to one or more writable parameters of the one or more device processing machines 132. In other embodiments, the machine instruction sets indicate one or more operational states corresponding to the device processing machines 132.

At operation 712, the device processing machine 132 (e.g., a controller framework 510 of the device processing machine 132) authenticates the sender of the machine instructions set. Authenticating (712) the sender of the machine instruction sets may include determining whether the machine instruction sets were received from an authorized entity such as server system 131. In at least some embodiments, authenticating the sender of the machine instruction sets includes determining whether a device communicating operations or instructions is authorized to provide such instructions by verifying that the instructions are received via the corresponding server system 131, which is authorized to control the device processing machine(s) 132. In at least some embodiments, authenticating the sender of the machine instruction sets includes confirming whether a client device providing instructions to the server system 131 is authorized to update the device processing machine parameters. In some embodiments, the server system 131 is configured to reject parameter instructions from devices which are not authorized to provide such instructions, and therefore the device processing machine 132 may not be required to authorize client devices accordingly. In at least some embodiments, authenticating the sender of the machine instruction sets includes verifying a certificate at the client side and/or the server side.

At operation 714, the device processing machine 132 (e.g., a controller framework 510 of the device processing machine 132) configures machine parameters according to the instructions set. Configuring (714) machine parameters according to the instruction sets may include automatically reconfiguring a function of at least one of the plurality of device processing machines via the operational state update process(es) discussed herein. In various embodiments, the device processing machine 132 adjusts parameters corresponding to the machine instructions set according to an indicated operational state. For example, for a first operational state configured to process only devices corresponding to a specific model, the at least one device processing machine 132 is configured to filter devices according to specifications of the specific model, and updates its parameters to reflect this function to process only devices meeting the specifications of the specific model. Similarly, for a second operational state configured to process only devices above a certain quality threshold, the device processing machine 132 is configured to filter devices according to specifications associated with the defined quality threshold, such as grade, screen condition, button condition, scrapes and scratches on the body of the device, and the like, and updates its parameters to reflect the defined quality threshold.

At operation 716, the device processing machine 132, or the controller framework 510 of the device processing machine 132, provides machine operational data to the server system 131. Providing (716) operational data to the server system may include monitoring machine operations of the device processing machine 132 and tracking throughput data corresponding to the monitored machine operations. For example, the controller framework 510 may be configured to track how many total devices, devices of each type, devices of each operating system, devices of each make, devices of each model, devices of each condition, devices of each memory size, devices of each screen size, devices of each color, devices of each style, and/or the like are processed by operations of device processing machine 132. controller framework 510 may additionally be configured to monitor how long the device processing machine 132 takes to process each device, and provide duration data corresponding to the devices according to the aforementioned characteristics. For example, the device processing machine 132 may be configured to provide data (i) indicating aggregated data regarding total processed devices over a period of time, optionally sorted by device characteristic, and (ii) indicating timing/duration data regarding the devices processed by the device processing machine 132, indicating whether there are distinct differences in the time it takes a machine to process devices of different models, for example. In some embodiments, the controller framework 510 may be configured to detect and report anomalies such as electronic or cosmetic defects, underperformance, faults, error codes, and the like.

At operation 718, the server system 131 receives machine operational data from the device processing machine 132. Receiving (718) machine operational data from the device processing machine 132 may include any of the aforementioned sets of operational data, including but not limited to data reflecting total device processing data and/or timing/duration data regarding how quickly the device processing machine 132 is processing devices of different characteristics and/or anomaly data. In at least some embodiments, server system 131 receives machine operational data from a plurality of device processing machines in addition to device processing machine 132.

At operation 720, the server system 131 (e.g., a signal analysis framework 420 of the server system 131) determines updated instructions based on the operational data. Determining (720) updated instructions based on the operational data may include determining whether the operational data as received reflects a desired state of processing, for example as indicated by the user provided commands. In some embodiments, the state of processing may be sufficiently deficient (e.g., below a threshold operational metric) such that the server system determines that the corresponding device processing machine is malfunctioning. For example, if the user command requested that devices of a first model be processed at an indicated increased rate, determining updated instructions based on the operational data may include determining whether the operational data reflects that the indicated increased rate of processing corresponding to the user command has been met by the corresponding device processing machine 132. If the operational data indicates that the rate of processing has not met the requirements of the request, determining (720) updated instructions may include identifying an operational state for the device processing machine 132 (and/or one or more additional device processing machines 132) which further prioritize the first model. In an embodiment where server system 131 may issue commands to a plurality of device processing machines, determining updated instructions may include determining instructions to be provided to additional device processing machines to meet the prioritization requests of the user provided commands and/or changing the priority of the subject device processing machine to a function for which it has better performance.

In at least some embodiments, determining updated instructions based on the operational data may include detecting a malfunction corresponding to the device processing machine 132 according to the operational data. For example, detecting a malfunction may include determining that the device processing machine 132 is displaying significantly (e.g., below a threshold) decreased device throughput or increased error rate relative to previous measured time intervals with respect to any or all device characteristics, significantly different device throughput or increased error rate relative to other device processing machines of a same type, significantly decreased device throughput or increased error rate relative to a predetermined acceptable throughput/error rate threshold, and/or other factors such as a device queue length at the device processing machine. More specifically, in some embodiments, detecting a malfunction may include determining that one specific operation of the device processing machine 132 and/or one specific device processing machine 132 of a plurality of device processing machines is exhibiting significant delays according to the various aforementioned methods. For example, a device processing machine experiencing a malfunction in its capabilities of verifying a touchscreen's functions if it displays a largely decreased rate of throughput with respect to such device models with a touchscreen. Responsive to detecting such a malfunction, the server system 131 may determine appropriate updated instructions including rerouting devices away from the malfunctioning device processing machine entirely, or updating the machine's instructions to only process devices unaffected by the malfunction (such as devices which do not have a touchscreen, in the described example). In at least some embodiments, responsive to detecting a malfunction, determining updated instructions may further include generating a repair request to be sent to an entity responsible for managing such requests within the device processing system. The repair request may include details of the malfunction and identifying information corresponding to the malfunctioning device processing machine. Upon transmitting a “repaired” signal, closing the malfunction indication, or otherwise signaling that the device processing machine is repaired, the server system 131 may revert to a previous state and transmit instructions to the device processing machine(s) to cause the machine(s) to resume a previous operational state.

At operation 722, the server system 131 (e.g., a response command layer 420 of the server system 131) may send updated instructions to the device processing machine 132. Sending (722) updated instruction sets to the server system 131 may include transmitting, via a network, the updated machine instruction sets to one or more device processing machines including device processing machine 132 using substantially the same processes described with respect to operation 708. In various embodiments, server system 131 is configured to send a first subset of the updated machine instruction sets to one or more device processing machines of a first type. In such embodiments, server system 131 is configured to send a second subset of the updated machine instruction sets to one or more device processing machines of a second type. In some embodiments, the server system 131 may broadcast the device processing machine instruction set across a network (e.g., local area network) with identifiers indicating the recipient device processing machine of each instruction. In such embodiments, the updated machine instruction sets indicate one or more changes to machine parameters directly. In other embodiments, the updated machine instruction sets indicate one or more operational states corresponding to one or more affected device processing machines. In some embodiments, each device processing machine may store one or more operational states locally, such as by a designation (e.g., Mode A, Mode B, Mode C, etc.), and the transmitted instruction may indicate the mode in which to operate.

At operation 724, the device processing machine 132 (e.g., a controller framework 510 of the device processing machine 132) receives the updated instruction sets from the server using substantially the same processes described with respect to operation 710. Receiving (724) the updated instruction sets from the server may include receiving a network transmission comprising the updated machine instruction sets from the server system 131. In at least some embodiments, the updated machine instruction sets include one or more defined changes to one or more writable parameters of the one or more device processing machines 132. In other embodiments, the updated machine instruction sets indicate one or more operational states corresponding to the device processing machines 132.

At operation 726, the device processing machine 132 (e.g., a controller framework 510 of the device processing machine 132) configures machine parameters according to the updated instruction set using substantially the same processes described with respect to operation 714. Configuring (726) machine parameters based on the updated instruction set may include automatically reconfiguring a function of at least one of the plurality of device processing machines. In various embodiments, the device processing machine 132 adjusts parameters corresponding to the updated machine instructions set according to an indicated operational state. For example, for a first operational state configured to process only devices corresponding to a specific model, the at least one device processing machine 132 is configured to filter devices according to specifications of the specific model, and updates its parameters to reflect this function to process only devices meeting the specifications of the specific model. Similarly, for a second operational state configured to process only devices above a certain quality threshold, the device processing machine 132 is configured to filter devices according to specifications associated with the defined quality threshold, such as grade, screen condition, button condition, scrapes and scratches on the body of the device, and the like, and updates its parameters to reflect the defined quality threshold.

While the embodiments as described herein refer generally to “device processing machines” and corresponding parameterizations, control systems, and processes and apparatuses associated therewith, it should be appreciated that the device processing machines may take on a plurality of forms. Some machines may be configured to analyze a device's condition, some machines may be configured to determine a device's make or model, some machines may be configured to determine a device's battery health, and the like. Other device processing machines may be configured to manipulate or modify the devices (e.g., cleaning, buffing/polishing, repair, or the like with corresponding hardware, such as pads, cloths, arms, end effectors, etc.). Each variant of a device processing machine may be parameterized differently and may exhibit different operations corresponding to an operational state.

The various processes described herein are configured for use in any system environment, including, but not limited to, a reverse-logistics environment in which a provider may receive and process tens-of-thousands to millions of objects (e.g., mobile devices). Embodiments of the present systems, apparatuses (including devices), computer programs, and methods may be configured to facilitate parameterization of processing devices configured to process and otherwise manage the mobile devices, such that the processing devices may be remotely adjusted, both individually and collectively, to process the mobile devices according to a newly provided set of desired features.

It will be appreciated that while descriptions have been provided for the various entities configured to perform the various tasks discussed herein, the functions performed by the various entities may be encompassed by one or more sets of computer-coded instructions without requiring clear delineation between the entities, by combining the functions of multiple entities into one, and/or by separating sub-functions of one or more entities into discrete sub-entities.

### Example Machine Learning Framework

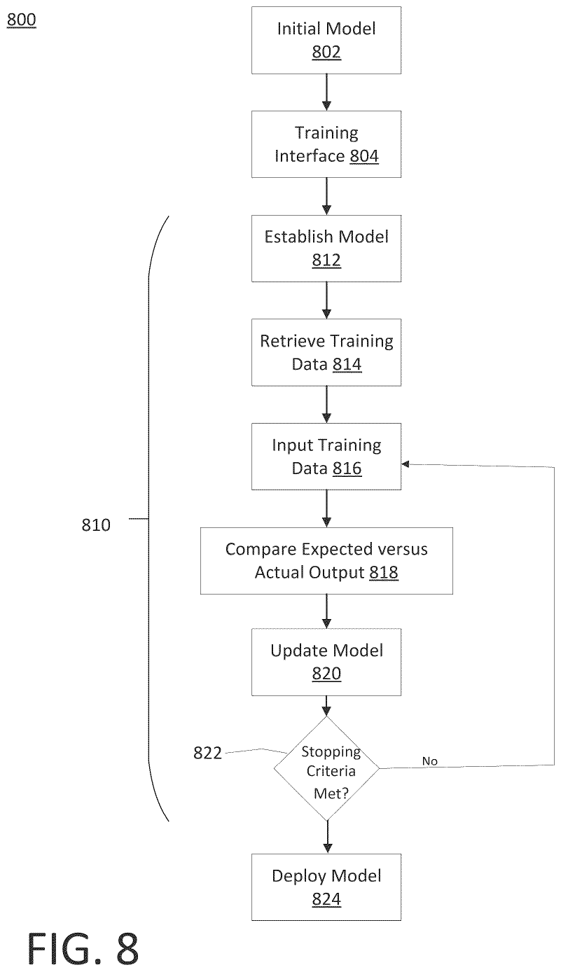

FIG. 8 illustrates an example machine learning framework 800 that techniques described herein may benefit from or improve on. A machine learning framework 800 is a collection of software and data that implements artificial intelligence trained to provide output, such as predictive data, based on input. Examples of artificial intelligence that may be implemented with machine learning way include neural networks (including recurrent neural networks), language models (including so-called “large language models”), generative models (e.g., transformers), natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 800 or components thereof are often built or refined from existing frameworks, such as TENSORFLOW by GOOGLE, INC. or PYTORCH by the PYTORCH community. The machine learning frameworks 800 may correspond to techniques as leveraged by the various data processors as described herein for various data processing functions.

The machine learning framework 800 may include one or more models 802 that are the structured representation of learning and an interface 804 that supports use of the model 802. The model 802 may include may take any of a variety of forms. In many examples, the model 802 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 802 may include a representation of memory (e.g., providing long short-term memory functionality). Where the set includes more than one model 802, the models 802 may be linked, cooperate, or compete to provide output.

The interface 804 may include software procedures (e.g., defined in a library) that facilitate the use of the model 802, such as by providing a way to establish and interact with the model 802. For instance, the software procedures may include software for receiving input, preparing input for use (e.g., by performing vector embedding, such as using Word2Vec, BERT, or another technique), processing the input with the model 802, providing output, training the model 802, performing inference with the model 802, fine tuning the model 802, other procedures, or combinations thereof.

In an example implementation, interface 804 may be used to facilitate a training method 810. The training method 810 may include operation 812, which includes establishing a model 802, such as initializing a model 802. The establishing may include setting up the model 802 for further use (e.g., by training or fine tuning). The model 802 may be initialized with values. In examples, the model 802 may be pretrained.

Operation 814 may follow operation 812. Operation 814 includes obtaining training data; in many examples, the training data includes pairs of input (e.g., training sequence data objects and respective contextual data objects) and desired output (e.g., labels) given the input. In supervised or semi-supervised training, the data may be prelabeled, such as by human or automated labelers. In unsupervised learning the training data may be unlabeled.

Many examples herein are related to supervised prediction of disruptions to pinpoint the weights or importance of events. But certain embodiments may operate without explicit labels but with implicit labels computed based on other data. Thus data need not be explicitly labeled. But it may be beneficial to use an input labeler to infer labels and to train a supervised model.

The training data may include validation data used to validate the trained model 802. Operation 816 may follow operation 814. Operation 816 includes providing a portion of the training data to the model 802. This may include providing the training data in a format usable by the model 802. The machine learning framework 800 (e.g., via the interface 804) may cause the model 802 to produce an output based on the input.

Operation 818 may follow operation 816. Operation 818 includes comparing the expected output with the actual output. In an example, this may include applying a loss function to determine the difference between expected and actual data. This value may be used to determine how training is progressing. Operation 820 may follow operation 818. Operation 820 includes updating the model 802 based on the result of the comparison. This may take any of a variety of forms depending on the nature of the model 802. Where the model 802 includes weights, the weights may be modified to increase the likelihood that the model 802 will produce correct output given an input. Depending on the model 802, backpropagation or other techniques may be used to update the model 802.

Operation 822 may follow operation 820. Operation 822 includes determining whether a stopping criterion has been reached, such as based on the output of the loss function (e.g., actual value or change in value over time). In addition, or instead, whether the stopping criterion has been reached may be determined based on a number of training epochs that have occurred or an amount of training data that has been used. In some examples, satisfaction of the stopping criterion may include if the stopping criterion has not been satisfied, the flow of the method may return to operation 814. If the stopping criterion has been satisfied, the flow may move to operation 822.

Operation 824 includes deploying the trained model 802 for use in production, such as providing the trained model 802 with real-world input data and produce output data used in a real-world process.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context - including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks.

By sharing model parameters and applying transfer learning techniques across customers, example embodiments may leverage the knowledge gained from one customer's transactional data to improve the forecasting for another. This transfer of learning allows the model to generalize across customers and capture common patterns and trends, resulting in more accurate predictions.

### Conclusion

Although an example processing system has been described above, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer storage medium for execution by, or to control the operation of, information/data processing apparatus. Alternatively, or in addition, the program instructions may be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate physical components or media (e.g., multiple CDs, disks, or other storage devices).

At least portions of the operations described herein may be implemented as operations performed by an information/data processing apparatus on information/data stored on one or more computer-readable storage devices or received from other sources.

The term “data processing apparatus” and similar terms encompass all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software program, software, software application, script, computer executable instructions, computer program code, code, and/or similar terminology) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A computer program may include electronically transmitted computer-executable instructions configured to cause a receiving device to perform one or more functions, including executing one or more pre-programmed functions of the recipient device and/or executing code received from the transmitting device. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output, which programmable processors may be incorporated into or otherwise in communication with the one or more apparatuses disclosed herein (e.g., the multi-axis robot, other tool(s), etc.). Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a client computer having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) may be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results.

### Example Embodiments of the Present Disclosure

Hereinafter, various characteristics will be highlighted in a set of numbered clauses or paragraphs, listed as “Examples”. These characteristics are not to be interpreted as being limiting on the disclosure or inventive concept, but are provided merely as a highlighting of some characteristics as described herein, without suggesting a particular order of importance or relevancy of such characteristics.

Example 1: A system comprises a device processing machine comprising network communication circuitry; and a controller comprising a non-transitory computer readable medium comprising computer program instructions that, when executed by a processor, cause the controller to execute one or more functions of the device processing machine, the computer program instructions defining one or more dynamic parameters comprising an integer and a listener function, the listener function configured to receive and monitor signals received by the network communication circuitry for one or more parameter update instructions, and wherein the device processing machine is configured to receive the one or more parameter update instructions and update at least one of the one or more dynamic parameters in response to the one or more parameter instructions to alter at least one function of the device processing machine.

Example 2: The system of Example 1, wherein one or more states of the one or more dynamic parameters are configured to place a corresponding function of the device processing machine into a defined operational state.

Example 3: The system of Example 2, wherein the defined operational state configures execution of the corresponding function of the device processing machine to provide a corresponding defined throughput condition.

Example 4: The system of any of the preceding Examples, wherein the one or more dynamic parameters correspond to a writable variable configured to trigger a change in the writable variable responsive to a received parameter instruction.

Example 5: The system of any of the preceding Examples, wherein the device processing machine is configured to capture at least one image of a device and generate a grade of the device based on an analysis of the at least one image, and wherein one or more states of the at least one of the one or more dynamic parameters configure the functioning of one or more grading criteria elements of the device processing machine such that a threshold for a specific grade is adjusted according to the one or more states of the dynamic parameter.

Example 6: The system of any of the preceding Examples, wherein the device processing machine is configured to send a device to two or more locations based on an outcome of analysis of the device, and wherein one or more states of the dynamic parameter configure how the device processing machine filters devices to the two or more locations based on the analysis of the device.

Example 7: The system of Example 6, wherein the one or more states of the dynamic parameter configure operation of one or more routing mechanisms configured to send the device to the two or more locations.

Example 8: A computer-implemented method comprising defining one or more dynamic parameters comprising an integer and a listener function of a device processing machine, the listener function configured to receive and monitor signals received by a corresponding network communication circuitry for one or more parameter instructions, receiving the one or more parameter update instructions, and updating at least one of the dynamic parameters in response to the one or more parameter instructions to alter at least one function of the device processing machine.

Example 9: The computer-implemented method of Example 8, wherein one or more states of the one or more dynamic parameters are configured to place a corresponding function of the device processing machine into a defined operational state.

Example 10: The computer-implemented method of any of Examples 8-9, wherein the defined operational state configures execution of the corresponding function of the device processing machine to provide a corresponding defined throughput condition.

Example 11: The computer-implemented method of any of Examples 8-10, wherein the one or more dynamic parameters correspond to a writable variable in a code base of the device processing machine configured to trigger a change in the writable variable responsive to a received parameter instruction.

Example 12: The computer-implemented method of any of Examples 8-11, wherein the device processing machine is configured to grade devices, and wherein one or more states of the at least one of the one or more dynamic parameters configure the functioning of one or more grading criteria elements of the device processing machine such that a threshold for a specific grade is adjusted according to the one or more states of the dynamic parameter.

Example 13: The computer-implemented method of any of Examples 8-12, wherein the device processing machine is configured to send a device to two or more locations based on an outcome of analysis of the device, and wherein one or more states of the dynamic parameter configure how the device processing machine filters devices to the two or more locations based on the analysis of the device.

Example 14: The computer-implemented method of Example 13, wherein the one or more states of the dynamic parameter configure operation of one or more routing mechanisms configured to send the device to the two or more locations.

Example 15: At least one non-transitory computer-readable storage medium having computer program code stored thereon that, in execution with at least one processor, configures the at least one processor to define one or more dynamic parameters comprising an integer and a listener function of a device processing machine, the listener function configured to receive and monitor signals received by a corresponding network communication circuitry for one or more parameter update instructions, receive the one or more parameter update instructions, and update at least one of the one or more dynamic parameters in response to the one or more parameter instructions to alter at least one function of the device processing machine.

Example 16: The at least one non-transitory computer-readable storage medium of Example 15, wherein one or more states of the one or more dynamic parameters are configured to place a corresponding function of the device processing machine into a defined operational state.

Example 17: The at least one non-transitory computer-readable storage medium of Example 16, wherein the defined operational state configures execution of the corresponding function of the device processing machine to provide a corresponding defined throughput condition.

Example 18: The at least one non-transitory computer-readable storage medium of any of Examples 15-17, wherein the one or more dynamic parameters correspond to a writable variable in a codebase of the device processing machine configured to trigger a change in the writable variable responsive to a received parameter instruction.

Example 19: The at least one non-transitory computer-readable storage medium of any of Examples 15-18, wherein the device processing machine is configured to grade devices, and wherein one or more states of the at least one of the one or more dynamic parameters configure the functioning of one or more grading criteria elements of the device processing machine such that a threshold for a specific grade is adjusted according to the one or more states of the at least one of the one or more dynamic parameter.

Example 20: The at least one non-transitory computer-readable storage medium of any of Examples 15-19, wherein the device processing machine is configured to send a device to two or more locations based on an outcome of analysis of the device, and wherein one or more states of the at least one of the one or more dynamic parameters configure how the device processing machine filters devices to the two or more locations based on the analysis of the device.

Example 21: A system comprising at least one client terminal configured to receive input commands from a user, a plurality of device processing machines each comprising a controller, and at least one server in electronic communication with the at least one client terminal and the plurality of device processing machines via a network, the at least one server comprising at least one processor and at least one non-transitory computer readable medium comprising computer program instructions that, when executed by the at least one processor, cause the at least one server to: receive the input commands from the at least one client terminal, translate the input commands into one or more device processing machine instruction sets, the device processing machine instruction sets comprising at least one updated dynamic parameter configured to update an existing dynamic parameter of at least one of the plurality of device processing machines, and transmit one or more instruction sets to the at least one of the plurality of device processing machines to automatically reconfigure a function of the at least one of the plurality of device processing machines.

Example 22: The system of Example 21, wherein the computer program instructions, when executed by the at least one processor, further cause the system to receive operational data corresponding to the plurality of device processing machines, and determine one or more performance metrics of the plurality of device processing machines based on the operational data.

Example 23: The system of any of Examples 21-22, further comprising a translation framework configured to translate user input to a set of parameter update instructions to each of the plurality of device processing machines, wherein the set of parameter update instructions for a corresponding device processing machines configures the corresponding device processing machine to execute a function according to an overall initial goal of the user input.

Example 24: The system of any of Examples 21-23, wherein translating the input commands into one or more device processing machine instruction sets comprises applying the input commands to a generative AI model to create the one or more instruction sets, and wherein the set of parameter update instructions include instructions corresponding to prioritization of processing devices of the generative AI model.

Example 25: An apparatus comprising at least one processor and at least one non-transitory computer readable storage medium comprising computer program instructions that, when executed by the at least one processor, cause the at least one processor to receive an input command for configuring one or more device processing machines, translate the input command into at least one parameter update instruction set corresponding to the one or more device processing machines, and provide the at least one parameter update instruction set to the one or more device processing machines.

Example 26: The apparatus of Example 25, wherein the computer program instructions, when executed by the at least one processor, further cause the at least one processor to detect a machine malfunction associated with at least one of the one or more device processing machines based at least in part on a set of received operational data, and transmit one or more instruction sets to the at least one of the one or more device processing machines configured to automatically reconfigure a function of the at least one of the one or more device processing machines to compensate for the machine malfunction.

Example 27: The apparatus of any of Examples 25-26, wherein the computer program instructions, when executed by the at least one processor, further cause the at least one processor to send one or more repair instruction sets responsive to detecting the machine malfunction.

Example 28: The apparatus of any of Examples 25-27, wherein the one or more device processing machines comprises a visual inspection machine comprising at least one programmable logic controller.

Example 29: The apparatus of any of Examples 25-28, wherein the computer program instructions, when executed by the at least one processor, further cause the at least one processor to send a first set of parameter update instructions to a first subset of the one or more device processing machines, and send a second set of parameter update instructions to a second subset of the one or more device processing machines.

Example 30: The apparatus of any of Examples 25-29, wherein the computer program instructions, when executed by the at least one processor, further cause the at least one processor to automatically integrate a new machine into a system comprising the one or more device processing machines by transmitting the one or more instruction sets to the new machine, thereby configuring the new machine according to an operating mode of the one or more instruction sets.

Example 31: The apparatus of any of Examples 25-30, wherein the computer instructions, when executed by the at least one processor, further cause the at least one processor to receive one or more signals from the one or more device processing machines indicative of device throughput with respect to the one or more device processing machines, detect a system wide throughput issue based at least in part on the device throughput, and transmit one or more parameter update instruction sets configured to rebalance the flow of devices through the one or more device processing machines to improve the device throughput of the system.

Example 32: At least one non-transitory computer-readable storage medium having computer program code stored thereon that, in execution with at least one processor, configures the at least one processor to receive an input command for configuring one or more device processing machines, translate the input command into at least one parameter update instruction set corresponding to the one or more device processing machines, and provide a portion of the at least one parameter update instruction set to each of the one or more device processing machines.

Example 33: The at least one non-transitory computer-readable storage medium of Example 32, wherein the computer program code stored thereon, in execution with at least one processor, further configures the at least one processor to detect a machine malfunction associated with at least one of the one or more device processing machines based at least in part on a set of received operational data, and transmit one or more instruction sets to the at least one of the one or more device processing machines configured to automatically reconfigure a function of the at least one of the one or more device processing machines to compensate for the machine malfunction.

Example 34: The at least one non-transitory computer-readable storage medium of any of Examples 32-33, wherein the computer program code stored thereon, in execution with at least one processor, further configures the at least one processor to send one or more repair instruction sets responsive to detecting the machine malfunction.

Example 35: The at least one non-transitory computer-readable storage medium of any of Examples 32-34, wherein the one or more device processing machines comprises a visual inspection machine comprising at least one programmable logic controller.

Example 36: The at least one non-transitory computer-readable storage medium of any of Examples 32-35, wherein the computer program code stored thereon, in execution with at least one processor, further configures the at least one processor to send a first set of parameter update instructions to a first subset of the one or more device processing machines, and send a second set of parameter update instructions to a second subset of the one or more device processing machines.

Example 37: The at least one non-transitory computer-readable storage medium of any of Examples 32-36, wherein the computer program code stored thereon, in execution with at least one processor, further configures the at least one processor to automatically integrate a new machine into a system comprising the one or more device processing machines by transmitting the one or more instruction sets to the new machine, thereby configuring the new machine according to an operating mode of the one or more instruction sets.

Example 38: The at least one non-transitory computer-readable storage medium of any of Examples 32-37, wherein the computer program code stored thereon, in execution with at least one processor, further configures the at least one processor to receive one or more signals from at least one of the one or more device processing machines indicative of device throughput with respect to the at least one of the one or more device processing machines, detect a system wide throughput issue based at least in part on the device throughput, and transmit one or more parameter update instruction sets configured to rebalance a flow of devices through the at least one of the one or more device processing machines to improve the throughput of the system.

Example 39. A computer-implemented method comprising receiving, by one or more processors, an input command for configuring one or more device processing machines, translating, by the one or more processors, the input command into at least one parameter update instruction set corresponding to the one or more device processing machines, and providing, by the one or more processors, the at least one parameter update instruction set to the one or more device processing machines.

Example 40: The computer-implemented method of Example 39, further comprising
receiving, by the one or more processors, one or more signals from the one or more of device processing machines indicative of device throughput with respect to the one or more of device processing machines;
detecting, by the one or more processors, a system wide throughput issue based at least in part on the device throughput; and
transmitting, by the one or more processors, one or more parameter update instruction sets configured to rebalance a flow of devices through the one or more of device processing machines to improve the throughput of the system.

1. A system comprising:
a device processing machine comprising:
network communication circuitry; and
a controller comprising a non-transitory computer readable medium comprising computer program instructions that, when executed by a processor, cause the controller to execute one or more functions of the device processing machine, the computer program instructions defining one or more dynamic parameters comprising an integer and a listener function, the listener function configured to receive and monitor signals received by the network communication circuitry for one or more parameter update instructions; and
wherein the device processing machine is configured to receive the one or more parameter update instructions and update at least one of the one or more dynamic parameters in response to the one or more parameter instructions to alter at least one function of the device processing machine.

2. The system of claim 1, wherein one or more states of the one or more dynamic parameters are configured to place a corresponding function of the device processing machine into a defined operational state.

3. The system of claim 2, wherein the defined operational state configures execution of the corresponding function of the device processing machine to provide a corresponding defined throughput condition.

4. The system of claim 1, wherein the one or more dynamic parameters correspond to a writable variable configured to trigger a change in the writable variable responsive to a received parameter instruction.

5. The system of claim 1, wherein the device processing machine is configured to capture at least one image of a device and generate a grade of the device based on an analysis of the at least one image, and wherein one or more states of the at least one of the one or more dynamic parameters configure the functioning of one or more grading criteria elements of the device processing machine such that a threshold for a specific grade is adjusted according to the one or more states of the dynamic parameter.

6. The system of claim 1, wherein the device processing machine is configured to send a device to two or more locations based on an outcome of analysis of the device, and wherein one or more states of the dynamic parameter configure how the device processing machine filters devices to the two or more locations based on the analysis of the device.

7. The system of claim 6, wherein the one or more states of the dynamic parameter configure operation of one or more routing mechanisms configured to send the device to the two or more locations.

8. A computer-implemented method comprising:
defining one or more dynamic parameters comprising an integer and a listener function of a device processing machine, the listener function configured to receive and monitor signals received by a corresponding network communication circuitry for one or more parameter instructions;
receiving the one or more parameter update instructions; and
updating at least one of the dynamic parameters in response to the one or more parameter instructions to alter at least one function of the device processing machine.

9. The computer-implemented method of claim 8, wherein one or more states of the one or more dynamic parameters are configured to place a corresponding function of the device processing machine into a defined operational state.

10. The computer-implemented method of claim 8, wherein the defined operational state configures execution of the corresponding function of the device processing machine to provide a corresponding defined throughput condition.

11. The computer-implemented method of claim 8, wherein the one or more dynamic parameters correspond to a writable variable in a code base of the device processing machine configured to trigger a change in the writable variable responsive to a received parameter instruction.

12. The computer-implemented method of claim 8, wherein the device processing machine is configured to grade devices, and wherein one or more states of the at least one of the one or more dynamic parameters configure the functioning of one or more grading criteria elements of the device processing machine such that a threshold for a specific grade is adjusted according to the one or more states of the dynamic parameter.

13. The computer-implemented method of claim 8, wherein the device processing machine is configured to send a device to two or more locations based on an outcome of analysis of the device, and wherein one or more states of the dynamic parameter configure how the device processing machine filters devices to the two or more locations based on the analysis of the device.

14. The computer-implemented method of claim 13, wherein the one or more states of the dynamic parameter configure operation of one or more routing mechanisms configured to send the device to the two or more locations.

15. At least one non-transitory computer-readable storage medium having computer program code stored thereon that, in execution with at least one processor, configures the at least one processor to:
define one or more dynamic parameters comprising an integer and a listener function of a device processing machine, the listener function configured to receive and monitor signals received by a corresponding network communication circuitry for one or more parameter update instructions;
receive the one or more parameter update instructions; and
update at least one of the one or more dynamic parameters in response to the one or more parameter instructions to alter at least one function of the device processing machine.

16. The least one non-transitory computer-readable storage medium of claim 15, wherein one or more states of the one or more dynamic parameters are configured to place a corresponding function of the device processing machine into a defined operational state.

17. The least one non-transitory computer-readable storage medium of claim 16, wherein the defined operational state configures execution of the corresponding function of the device processing machine to provide a corresponding defined throughput condition.

18. The least one non-transitory computer-readable storage medium of claim 15, wherein the one or more dynamic parameters correspond to a writable variable in a codebase of the device processing machine configured to trigger a change in the writable variable responsive to a received parameter instruction.

19. The least one non-transitory computer-readable storage medium of claim 15, wherein the device processing machine is configured to grade devices, and wherein one or more states of the at least one of the one or more dynamic parameters configure the functioning of one or more grading criteria elements of the device processing machine such that a threshold for a specific grade is adjusted according to the one or more states of the at least one of the one or more dynamic parameter.

20. The least one non-transitory computer-readable storage medium of claim 15, wherein the device processing machine is configured to send a device to two or more locations based on an outcome of analysis of the device, and wherein one or more states of the at least one of the one or more dynamic parameters configure how the device processing machine filters devices to the two or more locations based on the analysis of the device.
